(19) United States
(12) Patent Application Publication
(10) Pub. No.: US 2009/0254529 A1
(43) Pub. Date: Oct. 8, 2009

(54) SYSTEMS, METHODS AND COMPUTER PROGRAM PRODUCTS FOR CONTENT MANAGEMENT

(76) Inventor: Lev Goldentouch, Rishon Lezion (IL)

Correspondence Address: Pearl Cohen Zedek Latzer, LLP, 1500 Broadway, 12th Floor, New York, NY, 10036, US

(21) Appl. No.: 12/416,947

(22) Filed: Apr. 2, 2009

Related U.S. Application Data
(60) Provisional application No. 61/042,564, filed on Apr. 4, 2008.

(51) Int. Cl. G06F 15/16; G06F 17/30; H04W 4/00; G06F 17/00

(52) U.S. Cl. 707/3; 709/203; 455/466; 715/243; 707/E17.108

(57) ABSTRACT

A system for managing content, the system including: (a) a memory for storing a source internet document that has been acquired over an internet connection; (b) a processor, configured to divide the source internet document into multiple granular elements, and to provide a group of interrelated granular elements; and to add metadata fields to the granular elements; wherein the processor is further configured to process granular element associated information that has been received from a web user, wherein the granular element associated information is associated with a referenced granular element that is selected in response to user selection, for generating, in response to metadata of at least one granular element, a second internet document that includes the referenced granular element, other granular elements, and the granular element associated information; and (c) an interface for providing the second internet document over an internet connection.

### CROSS REFERENCE TO RELATED APPLICATIONS

This application claims the benefit of U.S. Provisional Patent Application Ser. No. 61/042,564, filed on Apr. 4, 2008, entitled “System, Methods and Applications for Web Content Storage, Marking and Sharing”, which is incorporated in its entirety herein by reference.

### BACKGROUND OF THE INVENTION

The present invention relates generally to the field of web-based information exchange, subfields of web content storage, marking and sharing.

Several related technologies provide internet users with operations of storing web content and writing on web pages, creating web-base messages, controlling message reputation and monitoring messaging and advertising efficiency.

The URL-based web page bookmarking technology and offline document storage enable users with advanced access to web content. Web content storage software, such as Surfulator™ and Google Gears™ download web sites to local device for offline usage. Social bookmarking services such as Clipmarks™ and Google Notepad™ enable storage and sharing of web page URL and user selection from web documents, including text and images. Google Cache™ allowed a robot store web sites and Ma.gnolia allowed user to store web pages on remote servers. The URL-based web page bookmarking technology does not provide good solutions in terms of storage and making of changing, dynamically generated and password-protected web pages.

URL bookmarking deficiency 1: Frames. Web pages may contain embedded objects including frames or IFrames. Each frame may be based on a different markup source. Changes and navigation inside embedded objects may be not available via URL. Therefore the URL-based bookmark may not reflect die state of the embedded frames.

URL bookmarking deficiency 2: Dynamically generated content. Certain technologies, such as Javascript and PHP enable dynamic generation of web pages. In dynamic content generation a fixed URL may correspond to web content changing per request.

URL bookmarking deficiency 3: Content modifications. Over time the web pages become obsolete and may be moved, updated or deleted. These modifications are not reflected in URL, which may address pages that have been modified or deleted.

URL bookmarking deficiency 4: Password protection. Access to password-protected pages may be restricted to the users. Sharing of protected pages may not allowed by sites, while required by users.

Web annotation services such as DIIGO™ and TrailFire™ enable users to highlight and add text notes on web page text. Graphics annotation services, such as Graphita™ and Photonotes™ enable users to write and draw on web-hosted images.

Web annotation deficiency 1: Different technologies may be used for marking various type of web content. Marking of different types of content may be performed with qualitatively different technologies. Text annotation services may not provide image/video annotation capabilities and vice-versa. Marking web-page combining text, images and video may require usage of several different service providers.

Web annotation deficiency 2: Web annotation systems may come with built-in web publishing tools, which may limit integration with multiple third-party messaging tools, such as email, SMS and social networks, or other suitable messaging technologies.

Web annotation deficiency 3: Web annotation systems typically are based on URL bookmarking and may have similar deficiencies with content which may be password-protected, dynamically generated or modified over time.

Messaging systems enable users with communication and sharing capabilities. Targeted marketing services, such as ConstantContact™ and iContact™ provide platform that enables users to easily create, publish, and track email newsletters, surveys, blogs, autoresponders, and RSS feeds. Messaging tools, such as Twitter™ and Pouicer™ enable integration of multiple messaging media.

Messaging deficiency 1: SPAM messages. Sending inappropriate messages may have little effect on user's reputation in some messaging services, which enables creation of inappropriate messaging. As a result, users may receive inappropriate messages which may be malicious, annoying or time-wasting. Some systems, developed in order to deal with SPAM messages, cause deletion of important messages, that incorporate some words or phrases. Some systems deal malicious users and advertise high-profile users via with reputation-based user filtering, however the reputation-based filtering does not typically apply to third-party messaging services.

Messaging deficiency 2: No user incentive for beneficial behavior. The users of typical messaging systems do not have a monetized reputation and financial incentive for beneficial activity, such as, by way of illustration, creation and forwarding of “good” messages.

Messaging deficiency 3: Inefficient information. Typical messaging systems either enforce very short messages with no background information, or enable very long messages that may be hard to read. However, most users want all the relevant information and only the relevant information.

Reputation management systems are available in many commercial products. Several services, such as SlashDot™ and Ebay™ provide user reputation management as a tool for improving transaction effectiveness. In Ebay™ reputation may correspond to trusted dealer and is determined by voting. In Facebook™ reputation may be monetized by AceBucks™ and may provide measure of social activity. In SecondLife™ reputation is monetized by LindonDollars™, that are a tradable currency of the virtual world. Wikipedia™ and SlashDot™ use a complex form of reputation and moderation of articles. Naymz™ uses RepScore™ as a measure of full and authenticated user profile. Google™ uses a complex PageRank™ system to calculate reputation of a site. The reputation management subsystems are typically custom-build for the proposed business model, generating user incentive to exhibit some sort of behavior. However, custom-building reputation management system to third-party messaging systems is a non-trivial task.

FIG. 1 illustrates a typical architecture of a prior art annotation system 199, which includes components 101-111, as discussed below.

Hosting authority 101 provides storage, annotation, sharing and other suitable services. The hosting authority may be based on distributed architecture with several servers sharing common communication infrastructure.

Element 101 block 106: Storage server 106 may handle data storage, transaction information, selected URLs, selected content and other suitable database and file system access operation.

Element 101 block 107: User support server 107 may handle user activities, comments, annotations, manages user collections and communication between users.

Element 101 block 108: Advertising server 108 may control contextual information, web analytics, advertising and premium services.

Element 101 block 109: Overlay server 109 may provide visual integration between data from content provider, user comments, user toolbars, hosting authority and other suitable data sources.

Content provider 102 provides the original content over which services like user annotation may be performed.

Advertiser 103 provides promotional content to be displayed for target audience of users, billing information, requests for premium services and other suitable monetization requests.

Distribution network 104 allows distribution of the content to the relevant users.

Element 104 block 110: Internet/Content download network [CDN] 110 is the content distribution network based on internet infrastructure that delivers the content of interest for PC users 105.

Element 104 block 111: Email 111 may traditionally be used to send selected content “To a friend”, e.g. “Send to a friend” operation.

PC users 105 are users working with personal computer devices, including by way of illustration PCs, laptops, network terminals, pocket computers or other suitable computational device.

FIG. 2 presents a typical design of a prior art annotation system hosting authority 101, which includes components 106-109 and 201-206. The content engine 201 may perform several content-related operations: (a) verify that the page corresponding to URL exists and can be remotely accessed; (b) retrieve the original web page that is generated by content provide; (c) store the page URL and user selection on the page.

The comment engine 202 may perform several comment-related operations: (a) Manage user name, security and detail; (b) Manage user comments text and location; (c) Retrieve comments of other users which are relevant to the URL processed by content engine 201.

The smart proxy 203 may provide enhanced transport infrastructure for combination of content via content engine 201 and comments via comment engine 202. The smart proxy may include, by way of illustration, granular data caching, distributed upload and download, quality of service enablement and other suitable mechanisms for data transport control. In case of multiple comments, smart proxy may enable navigation between comments in slideshow fashion.

The overlay display 204 may perform GUI and visualization-related operations: (a) Add dedicated toolbar; (b) Overlay visually user comments over the content, as provided by smart proxy 203; (c) Add functionality to user selection; (d) Add functionality for sharing interface 205.

The sharing interface 205 may enable sharing of the content with comments via suitable publishing and messaging media, including: (a) Publish on web; (b) Add to blog; (c) Send as email.

The advertising interface 206 enables data collection, analysis and transport for the mechanisms of web analytics, billing, security, privacy and other suitable data services for advertising and premium services.

FIG. 3A presents a typical design of a prior art annotation creation method 399. method 399 conveniently starts with Stage 301 of storing content selection, including by way of illustration, storage of URL, selected content and descriptors for location of selected content in the original document.

Stage 301 stage 304: Get document selection 304 using suitable handler for user input attributes, for example document.GetSelection( ) HTML mechanism. The text and the objects in the selected range may be selected by the user. Alternatively a user may select a single HTML object via GUI.

Stage 301 stage 305: Store selection position 302 using mechanisms for registering the selection in a document. Below is an illustrative embodiment:

Stage 301 stage 305 step 307: Store user name and URL. Username and URL identify the general context of annotation and may be used for retrieval stage 301.

Stage 301 stage 305 step 308: Store section via e.g. XPath. XPath is a standard for finding a section in HTML document via DOM tree. XPath may not work inside IFrames and dynamically generated DOM documents.

Stage 301 stage 305 step 309: Store position via e.g. XPointer. XPointer is a standard for counting characters inside a section. Typically XPointer or equivalent technique may used for selection of partial paragraph content and/or content spanning several paragraphs. XPointer applies to text, and not to images/flash/video etc. Typically, for reach media dedicated tools may be used, for example, measuring coordinates in terms of image pixels.

Stage 301 stage 306: Store selected content. The selection content may be used in user-generated notebook, emails, sharing sites or other suitable depository.

Stage 302: Store comment. User comment typically includes multiple elements which may be stored in application database linked to user selection.

Stage 302 step 310: Store tag and test. Tags may used to describe the comment in storage depository, by way of illustration including social bookmarking services. Comment text may be assigned by the user note to the content 301. Combination of comment text and tag may illustrate the user's interpretation of the selected content.

Stage 302 step 311: Store attachments. Images, audio, video and other objects may be uploaded as attachments to comments, selection or original document.

Stage 302 step 312: Store pointer to next comment. In case of multiple comments forming a slideshow, each comment may keep some form of pointer to the previous and/or to the next comment in the slideshow.

Stage 303: Share comment. Typically some comments are private, some are shared in group and some are public. Some engines enable emailing and blogging of comments. In some prior art products, a moderator approves comment before the comment becomes public.

FIG. 3B presents a typical design of a prior art annotation retrieval method 499, which conveniently starts with stage 401.

Stage 401: Load content selection. The selected content may loaded for a given URL and position inside URL.

Stage 401 stage 404: Retrieve relevant entries from the database, using username, URL, tag and other suitable identification information. Multiple entries may be retrieved, processed and displayed for a web page of interest. When the URL is password protected or is no more available, an error message is generated.

Stage 401 stage 405: Load selection position, using the following steps:

Stage 401 stage 405 step 407: Load section via XPath standard or other suitable XML parsing algorithm. When the document is modified and XML structure changed, an error message may be generated.

Stage 401 stage 405 step 408: Load selection via XPointer standard or other suitable character counting algorithm. When the text is dynamically generated, XPointer may be pointing to incorrect structure and an error message may be generated.

Stage 401 stage 406: Load selected content, including text, embedded objects, links and dynamically generated content.

Stage 402: Load comment. The details of the user comments may be loaded and displayed, including public comments from other user to the content of interest.

Stage 402 step 409: Load tag, including multiple tags, keywords and other suitable classification information.

Stage 402 step 410: Load comment text, including plain text or rich text formats.

Stage 402 step 411: Load attachments, including images and icons.

Stage 402 step 412: Load pointer to next comment when there are multiple ordered comments.

### SUMMARY OF THE INVENTION

A method for managing content, the method including: (a) acquiring a source internet document over an internet connection; (b) dividing the source internet document into multiple granular elements, to provide a group of interrelated granular elements; (c) adding metadata fields to the granular elements; (d) receiving granular element associated information from a web user, wherein the granular element associated information is associated with a referenced granular element that is selected in response to user selection; (e) generating a second internet document that includes the referenced granular element, other granular elements, and the granular element associated information, wherein the generating is responsive to metadata of at least one granular element; and (f) providing the second internet document over an internet connection.

A system for managing content, the system including: (a) a memory for storing a source internet document that has been acquired over an internet connection; (b) a processor, configured to divide the source internet document into multiple granular elements, and to provide a group of interrelated granular elements; and to add metadata fields to the granular elements; wherein the processor is further configured to process granular element associated information that has been received from a web user, wherein the granular element associated information is associated with a referenced granular element that is selected in response to user selection, for generating, in response to metadata of at least one granular element, a second internet document that includes the referenced granular element, other granular elements, and the granular element associated information; and (c) an interface for providing the second internet document over an internet connection.

A computer readable medium having a computer readable code embodied therein for managing content, the computer readable code including instructions for: (a) acquiring a source internet document over an internet connection; (b) dividing the source internet document into multiple granular elements, to provide a group of interrelated granular elements; (c) adding metadata fields to the granular elements; (d) receiving granular element associated information from a web user, wherein the granular element associated information is associated with a referenced granular element that is selected in response to user selection; (e) generating a second internet document that includes the referenced granular element, other granular elements, and the granular element associated information, wherein the generating is responsive to metadata of at least one granular element; and (f) providing the second internet document over an internet connection.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a typical architecture of a prior art annotation system;

FIG. 2 presents a typical design of a prior art annotation system hosting authority;

FIG. 3A presents a typical design of a prior art annotation creation method;

FIG. 3B presents a typical design of a prior art annotation retrieval method;

FIG. 4A illustrates a method for managing content, according to an embodiment of the invention;

FIGS. 4B and 4B illustrate different stages of a method for managing content, according to different embodiments of the invention;

FIG. 5A illustrates a system for managing content, according to an embodiment of the invention;

FIG. 5B illustrates a system for managing content, according to an embodiment of the invention;

FIG. 6 illustrates different components of a system for content management, according to an embodiment of the invention;

FIG. 7 illustrates a method for creating markers, according to an embodiment of the invention;

FIG. 8 illustrates a method for marker retrieval, according to an embodiment of the invention;

FIG. 9 illustrates a method for managing content, according to an embodiment of the invention;

FIG. 10 illustrates a method for retrieving content, according to an embodiment of the invention;

FIG. 11 illustrates a method for storing content, according to an embodiment of the invention;

FIG. 12 illustrates a method for merging content, according to an embodiment of the invention;

FIG. 13 illustrates a method for modifying marked content, according to an embodiment of the invention

FIG. 14 illustrates a method for managing marked content metadata, according to an embodiment of the invention;

FIG. 15 illustrates a method for sharing marked content, according to an embodiment of the invention;

FIG. 16 illustrates a method for monitoring messages, according to an embodiment of the invention;

FIG. 17 illustrates a method for marked content reputation computation based on measurable parameters, according to an embodiment of the invention;

FIG. 18 illustrates a method for user reputation computation, according to an embodiment of the invention;

FIG. 19 illustrates a second internet document, according to an embodiment of the invention;

FIG. 20 illustrates a method for pattern-based marking, according to an embodiment of the invention;

FIG. 21 illustrates a method for sharing content, according to an embodiment of the invention; and

FIG. 22 illustrates a method for managing talkbacks, according to an embodiment of the invention.

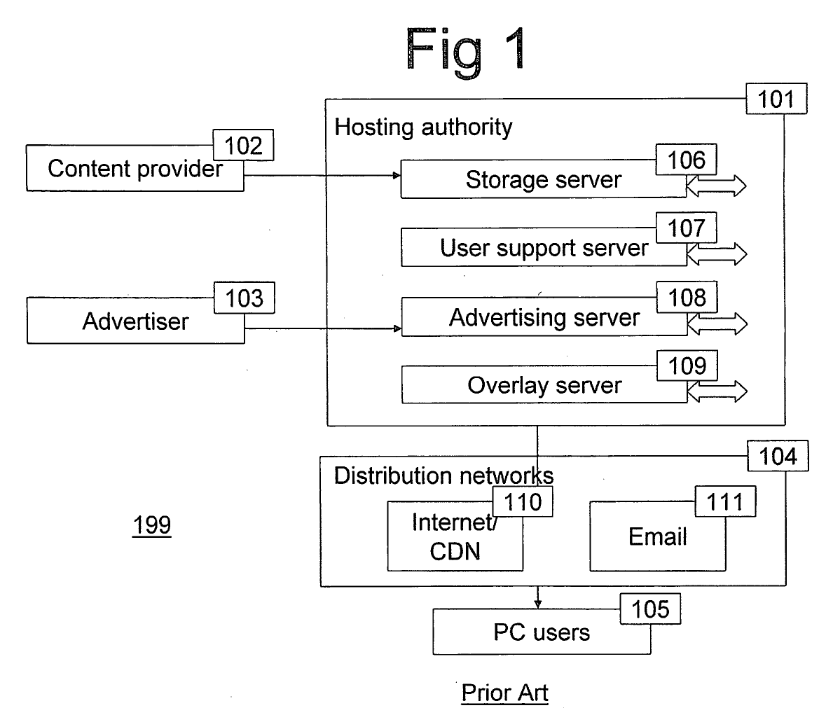

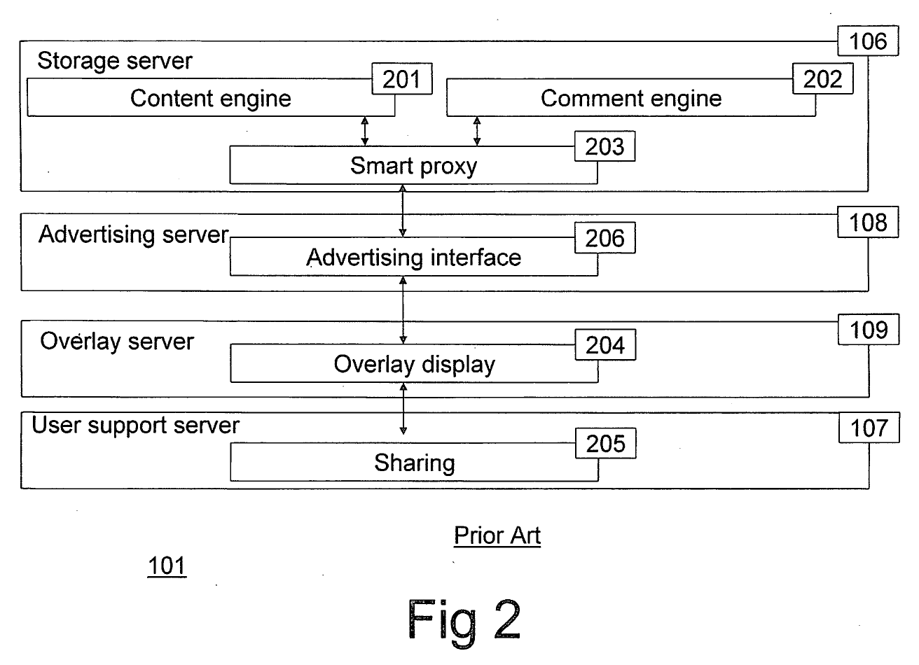

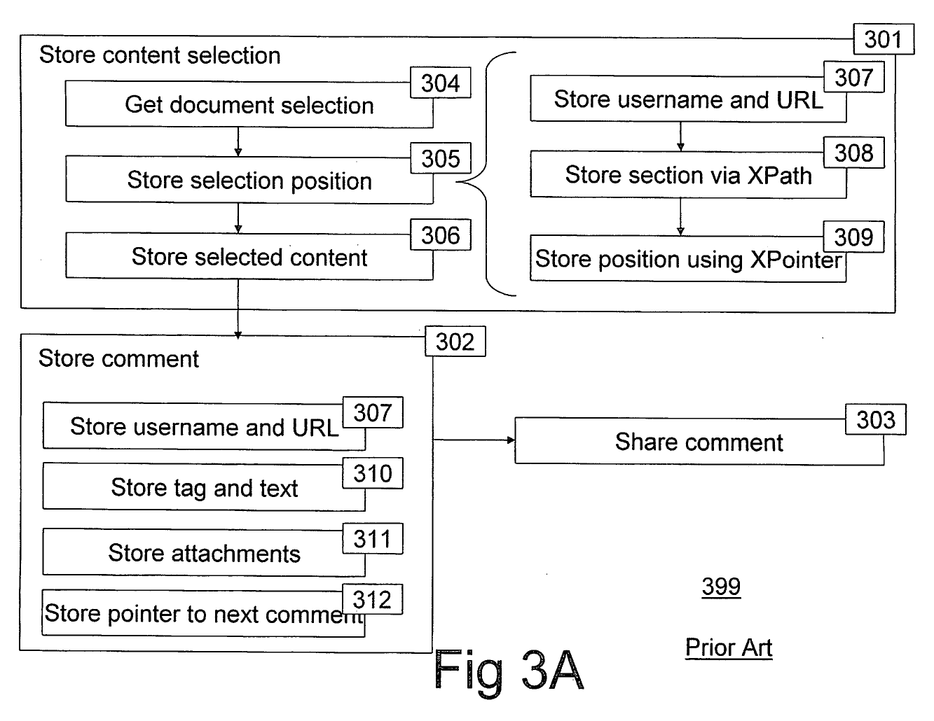

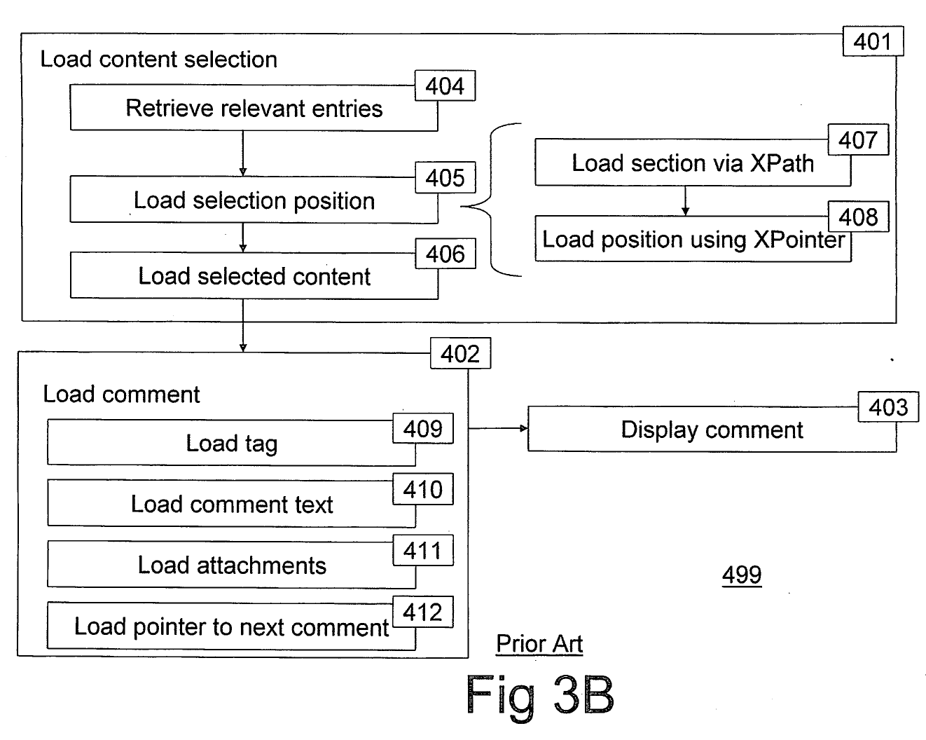

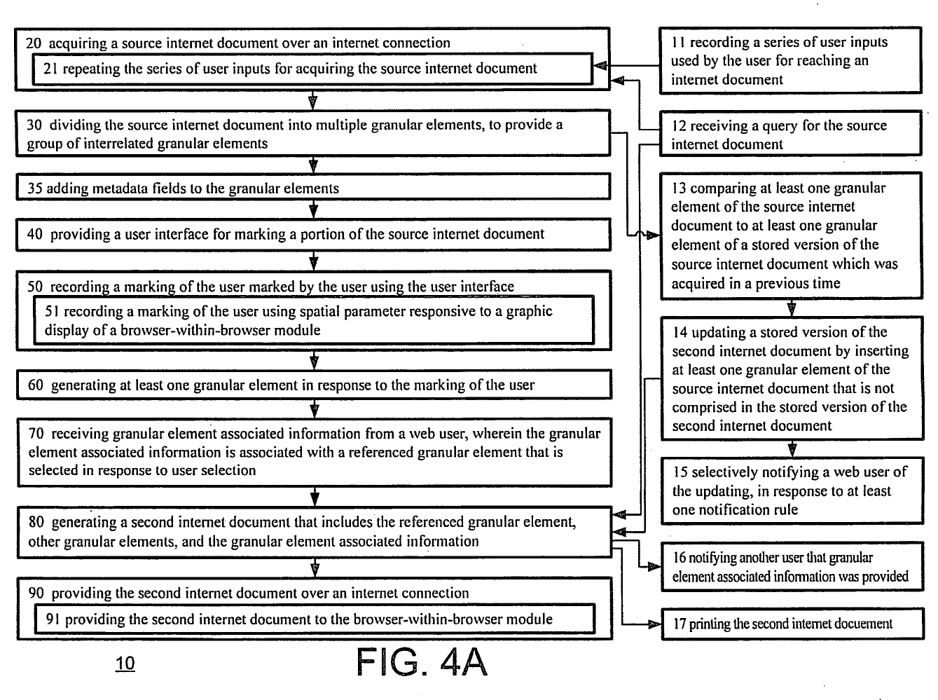

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The embodiments described herein are illustrative and non-limiting. Definitions are provided solely to assist one of ordinary skills in the art to better understand these illustrative, non-limiting embodiments. As such, these definitions should not be used to limit the scope of the claims more narrowly that the plain and ordinary meaning of the terms recited in the claims. With that caveat, the following definitions are used:
a. “Browser” may include an Internet browser capable of displaying formatted content such as, by way of illustration, HTML, WML, flash and proprietary XML, scripts formats, or any other suitable mechanism of displaying documents that may include mark-up language.
b. “Browser-in-browser technology” may include a technology that provides user with interface for browsing via remote proxy, rather than directly via a browser on local device. Browser-within-browser may present content from any URL within a hosting authority web page, so that users may navigate through searches, blogs and RSS feeds.
c. “Browsing experience” may include user subjective experience when using the browser. The term includes, by way of illustration, web navigation, browsing history, bookmarks, security, and automation. Examples of automation, by way of illustration, include single sign on and macros.
d. “Browsing history” may include content which a user may have previously accessed by the browser, and which may be available for re-visiting in the future.
e. “Client” may include a computational facility which may enable a browser and the browser's graphical capabilities.
f. “Computational facility” may include a computer, embedded processor, co-processor, computer network or other suitable device capable of digital signal processing and digital communication.
g. “Computer language” may include a protocol or format used within a computational facility or between computational facilities, including, by way of illustration, programming languages (such as Java), markup languages (such as DHTML), and communication protocols (such as HTTP).
h. “Device” may include a machine employing one or more digital processing units. The term includes, by way of illustration, a personal computer, a cellular phone, a PDA, an IPTV, a Play-station, and other devices employing digital processing units.
i. “DOM” The Document Object Model may include a platform- and language-independent standard object model for representing HTML or XML and related formats.
j. “Dynamically generate content” may include content generated via e.g. Javascript, PHP, ASP, Java, Flash or any other suitable content generation engine. The dynamic content generation may be based on user identity, cookies, user actions, timer, events or any other suitable context parameters. The dynamically generated content may provide multiple of visual results for a single URL. Multiple versions of HTML documents may correspond to a single underlying code.
k. “Hosted service” may include a service operated by a dedicated authority, in which said authority operates as a proxy to provide the service to all relevant customers. Examples of dedicated authorities include, by way of illustration, Internet service providers for personal PCs, cellular operators for mobile devices, and IPTV operators for IPTV-based internet access.
l. “HTML” may include an embodiment of formatted content adjusted for display in a browser, including, by way of illustration, HTML, WML, flash and proprietary XML, and scripts formats.
m. “IFrame” (from inline frame) may include an HTML element which makes it possible to embed another HTML document inside the main document. The embedded document may be modified without reloading the surrounding page, by suitable coding mechanisms which, by way of illustration, may include AJAX, Javascript, DHTM, Flaash. The dynamic update feature may enable interactive applications.
n. “Local device” may include a device, for which the user may have full administrative rights or has administrative rights related to the devices of other people, including, by way of illustration, personal home computer, personal mobile phone and personal pocket computer.
o. “Messaging” may include communication containing some information, news, advice, request, or the like, sent by messenger, SMS, e-mail, social web service or the like.
p. “National language” may include a human language, which would include, by way of illustration, English, Chinese, and Hebrew.
q. “Network” may include accessing electrical-mechanical communication network, including, by way of illustration, an Internet network (which may be accessed via the World Wide Web or via other means), other public networks, and private networks. Any such networks may be any level of security from none to the highest possible level. Any such networks may cover any geographic area (such as LAN or WAN), with any number or kind of devices on the network. Any such networks may be one-way in either direction (that is, from network center to remote device, or vice versa), or may be two-way. Any such networks may include various computational facilities. Examples of a “network” include an IPTV network, a TV broadcast network, a mobile telephony network, and a network of security cameras.
r. “Object” media may include rich media formats, including, by way of illustration, images, audio, video, synthetic graphics, and flash.
s. “Plug-in” may include a browser plug-in, by way of illustration, software provided by third party to a browser in order to increase the functional capabilities of the browser.
t. “Proxy” may include a computational facility which may store and/or modify the content from the server to be used in the browser.
u. “Server” may include a computational facility which may store formatted content.
v. “User” may include a human or a computer using the browser.
w. “Web” may include a system of interlinked web pages accessed via a network, including, by way of illustration, the World Wide Web over the Internet network.
x. “Web annotation” may include various operations that may provide the user with functionality of adding, modifying or removing information from a Web resource without modifying the resource itself. The annotations may include a layer on top of the existing resource, and this annotation layer may be visible to other users who share the same annotation system. By way of illustration, the web annotation may be social software tool for adding comments to web pages.
y. “Web navigation” may include various operations required to access specific content. Such operations include, by way of illustration, feeding-in an IP-address, feeding-in a server name, using bookmarks, using forward and backward navigation in browsing history, and using the “home button” on the browser.
z. “Web page” may include an object or document available in the web, including, by way of illustration, HTML documents, RSS feeds, RDF data, Flash objects, video streams, and music streams.

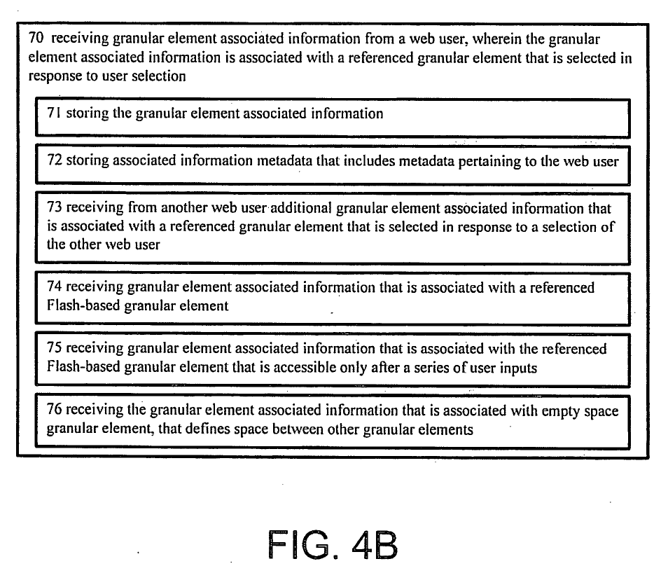

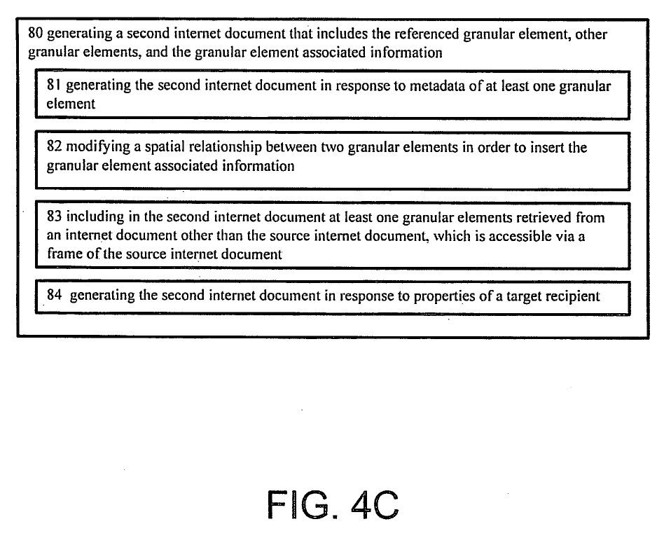

FIG. 4A illustrates method 10 for managing content, according to an embodiment of the invention. It is noted that conveniently, method 10 is carried out by a server, or a group of servers, which communicates information to and from web users. It is nevertheless further noted that method 10 may also be implemented by other systems, such as a home computer system, computers connected by peer-to-peer connection, and so forth, mutatis mutandis. It is further noted that method 10 may also be implemented, mutatis mutandis, for networks other than the internet (E.g. internal corporate network), and that those embodiments are incorporated herein by analogy, as is clear to a person who is skilled in the art.

Method 10 conveniently starts with stage 20 of acquiring a source internet document over an internet connection. It is noted that in different embodiments of the invention, different types of the source internet document may be acquired. For example, method 10 may be implemented for hypertext markup language (HTML) documents, for extensible markup language (XML) documents, for Adobe Flash documents, and so forth. It is noted that the source internet document acquired may include more than one type of encoding (e.g. an HTML document with an embedded Flash widget).

The acquiring of the source internet document may include acquiring the source internet document from a host, usually from a web-site. According to an embodiment of the invention, the acquiring of the source internet document is preceded by receiving a query (e.g. from a remote web user) for the source internet document, wherein the acquiring is carried out in response to such a received query. For example, the query may be by way of a uniform resource locator (URL) address (e.g. typed by the user, or selected by way of a hyperlink).

According to an embodiment of the invention, the receiving of the query is from a computer program product that is embedded in a browser of the querying user, and intercepts URL requests (e.g. from address bar, from links, from Flash controllers). According to an embodiment of the invention, the receiving of the query is from a browser-within-browser module used by the querying user on his computer (wherein the browser-within-browser module may be local and may be host remotely, e.g. on the server executing method 10).

It is noted that occasionally, the source internet document requires user operations for acquiring—for example, entering a username and a password, clicking on certain object/locations of a web-site, and so forth, and can not be accessed directly using only URL address. According to an embodiment of the invention, the acquiring of the source internet document includes providing such user input on behalf of the user. Such user may be entered by the user previously, or may be recorded on a previous access of the user to the same (or parallel) source internet document, or to the same URL.

According to an embodiment of the invention, the acquiring of the source internet document is preceded by stage 11 of recording a series of user inputs used by the user for reaching an internet document. It is noted that the recording of the series of user input may be facilitated by a browser-within-browser module, by an add-on or an applet incorporated into the browser of the user, and so forth.

According to an embodiment of the invention, the acquiring of the source internet document further includes stage 21 of repeating the series of user inputs for acquiring the source internet document, or at least a portion thereof.

It is noted that, according to an embodiment of the invention, the acquiring if the source internet document may further include acquiring embedded content such as, for example, frames, active objects, flash, images, documents accessible by clicking on links in the main document. The embedded content may be identified and stored iteratively, until reaching some stopping criteria. For example, store the content accessible via no more than two clicks. It is noted that the embedded content may be used for granular elements, as discussed below.

Stage 20 is followed by stage 30 of dividing the source internet document into multiple granular elements, to provide a group of interrelated granular elements.

Granular elements may represent, according to several embodiments of the invention objects, groups of objects or output of any suitable segmentation algorithm. For example, a text portion of the source internet documents may be divided into paragraph-sized granular elements, sentence-sized granular elements, word-sized granular elements, fixed-length strings granular elements, to text which resides within a geometric shape granular elements (regardless of linguistic structure), and so forth. Likewise, a picture granular element may include a picture, a part of a picture, parts of several pictures, and so forth. Also, a single granular element may include more than one type of information (e.g. all the information that resides within a given rectangle).

The dividing of the source internet document into granular document according to different embodiments of the invention is described in more details below, referring to further drawings of the disclosure.

It is noted that the dividing may and may not be responsive to user input, may be carried out in different times in relation to the acquiring (e.g. immediately after, few days later), and may also be an ongoing process, wherein information received in a later time is used for modifying the division of the source internet document into granular elements, modifying which may include changing the division, combining several previous granular elements into one, splitting a single granular elements into several, adding or removing granular elements layers, and so forth.

According to an embodiment of the invention, the dividing of the source internet document into multiple granular elements includes dividing into multiple granular elements according to a structure of the document and/or according to the metadata in (or of) each granular element.

By way of example, the dividing may be carried out according to HTML tree (divisions-paragraphs-spans), according to size (at least 10 words, or takes some place on the screen, or was updated at a certain date), and so forth.

According to an embodiment of the invention, the dividing includes dividing content of the source internet document in response to metadata associated with portions of the source internet document. It is noted that the dividing according to metadata may be, according to an embodiment of the invention, a dividing of a granular element into smaller elements in response to meta data of the larger granular element, of the smaller granular elements, of other portions of the source internet document, and of granular elements of other documents. This may take place, for example, when the dividing is a recursive process, e.g. as discussed below. It is however noted that according to an embodiment of the invention, may be a dividing of content of the source internet document which is not yet divided into granular elements, considering metadata that is either associated with that content, or with other content of the source internet document.

According to an embodiment of the invention, the dividing includes subdividing a portion of the source internet document (which may and may not be a granular element) in response to content of the portion. For example, if a paragraph includes a lot of text, it may be divided to sentences, while smaller paragraphs will not be divided.

According to an embodiment of the invention, the dividing includes dividing a portion of the source internet document in response to type of the content of the portion. For example, a certain image type may be divided to smaller images, while another graphic file will not be divided.

It is noted that all of those techniques may be combined.

It is noted that according to different embodiments of the invention, one or more user may modify, comment, or otherwise add information to the source internet document, or to depending documents that conveniently include substantial portions of the source internet documents. According to an embodiment of the invention, one of the ways in which a user can add information to the source internet document and/or affect a dividing of the source internet document to granular elements is by marking a portion of the source internet documents, e.g. using a graphical interface that enables a user to draw on the source internet document.

Method 10 conveniently continues with stage 35 of adding metadata fields to the granular elements, wherein metadata may be added to all of the granular elements, but this is not necessarily so.

It is noted that in different types of the invention, different types of metadata may be added to granular elements, wherein not necessarily all the granular elements are associated with the same types of metadata. It is also noted that metadata may be added to more than one granular element, and may pertain to more then one granular element—e.g. to a group of granular elements, or to relationships between granular elements.

For example, according to an embodiment of the invention, a spatial relationship may be defined for any granular element (and possibly all of them) in respect to at least one other granular element, but this is noted necessarily so. Spatial parameters of a granular element may also be defined in relation to other objects, such as size of a display window or frame, of the screen, of toolbars, and so forth.

According to an embodiment of the invention, the metadata of at least one granular element pertains to spatial parameters. According to an embodiment of the invention, the metadata of at least one granular element pertains to spatial relationships between two or more granular elements.

According to an embodiment of the invention, metadata of at least one granular element pertains to relevancy of search queries to the granular element. For example, a paragraph text may have added metadata pertaining to occurrences of search words within the text. However, relevancy of search queries to the granular element may be applied to non-textual granular objects as well, and may also be relevant to metadata of the granular element, or to granular element associated information, e.g. as discussed below.

According to an embodiment of the invention, metadata of at least one granular element pertains to a ranking of the granular element that is responsive to viewing of the granular element by users. Ranking may be determined, for example, by direct voting of users, and may also be determined in other ways such as times in which the granular element was viewed, references by search engines, comments by user (e.g. as granular element associated information), ranking of such comments or of commenting users, age, update rate, and so forth,

It should be noted that metadata may also be added to granular elements which have no visual manifestation such as name of an image file, and so forth.

According to an embodiment of the invention, metadata of at least one granular element pertains to temporal parameters of the granular element. Such temporal parameters may be related, for example, for times in which the granular element was generated, updated, modified, deleted, commented upon, and so forth.

According to an embodiment of the invention, method 10 includes stage 40 of providing a user interface for marking a portion of the source internet document. The user interface may be a stand alone computer program product, may be embedded in a browser of the user or incorporated into which, may be provided as an interface of the browser-within-browser module, and so forth. Conveniently, the providing of the user interface includes providing the user interface that enables the marking user to mark different types of content (e.g. by selecting content, by using drawing tools, and so forth) using one or more markings, and to comment on those markings. The user interface provided may also enables the user to comment on markings of other users or automatically generated markings.

It is noted that according to an embodiment of the invention, the provided user interface enables the user applying different processing procedures (such as caching, commenting, overlay, transcoding, advertizing) for these granular elements, for HTML granular elements and/or non-HTML granular elements.

According to an embodiment of the invention, method 10 includes stage 50 of recording a marking of the user that was marked by the user using the user interface. It is noted that the marking of the user may be modified during the recording (e.g. a semi-elliptic shape may be recorded as an ellipse), and the recording may include additional information (e.g. relation to granular elements, to other markings, to document layers, to granular elements layers, to spatial parameters of the document, and so forth).

According to an embodiment of the invention, stage 50 includes stage 51 of recording a marking of the user using spatial parameter responsive to a graphic display of a browser-within-browser module. For example, the spatial parameter responsive to a graphic display of a browser-within-browser module may be related to mouse movements, to screen size of the browser within browser, to the formation of the different parts of the source web document as presented within the browser-within-browser module, and so forth.

It is noted that spatial parameters responsive to such a graphic display may also be used for the recording of user operations, e.g. as disclosed in relation to stages 11 and 21.

It is noted that the recording of the marking may be followed by adding metadata to the marking (either as a granular element or otherwise). Such metadata may be similar to the metadata of granular elements referred to in relation to stage 85, but this is not necessarily so.

According to an embodiment of the invention, stage 50 is followed by stage 60 of generating at least one granular element in response to the marking of the user. It is noted that, as aforementioned, the marking of the user may be utilized in different ways for modifying the division of the source internet document to granular elements.

Method 10 continues with stage 70 of receiving granular element associated information from a web user, wherein the granular element associated information is associated with a referenced granular element that is selected in response to user selection. It is noted that, according to an embodiment of the invention, the referenced granular element may be otherwise selected (e.g. by the server that carried out method 10).

According to different embodiments of the invention, different types of granular element associated information may be received. For example, the granular element associated information may include one or more of the following: text comment, hyperlink, picture, video, voice notation, drawing-over, graphical markup, modification of behavior, modification of appearance, and so forth.

It is noted that, according to an embodiment of the invention, the referenced granular element may be selected by the user in different ways. According to an embodiment of the invention, the referenced granular element is at least partly referenced by a marking of the user.

As is further discussed below, according to an embodiment of the invention, the source internet document (or derivative internet documents) may be referred (having granular element associated information added) by more than one user, and/or each user may add more than once granular element associated information, to one or more granular elements.

Additionally, it is noted that the user who adds the granular element associated information is not necessarily aware of the division to granular elements, of a specific division, or of which granular element was selected.

It is further noted that, according to an embodiment of the invention, granular element associated information may also be generated by a computer (either remote computer, or by a computer which executes method 10), e.g. according to different processing rules, according to information previously stored in relation to other internet documents, and so forth.

It is noted that, according to an embodiment of the invention, the receiving of the granular element associated information is followed by storing associated information metadata that includes metadata pertaining to the web user, wherein the second internet document that is generated in stage 80 includes at least part of the associated information metadata.

It is noted that the granular elements of the source internet document and the granular element associated information may be stored on a server (or other memory component) for letter use, either together or separately. Also, the granular element associated information may be used (e.g. as discussed below according to different embodiments of the invention) independently of the source internet documents. For example, one such utilization may be presenting all the associated information provided by a certain user (with or without the corresponding referenced granular elements).

Method 10 continues with stage 80 of generating a second internet document that includes the referenced granular element, other granular elements, and the granular element associated information. It is noted that the second internet document may resemble the source internet document, but this is not necessarily so. According to an embodiment of the invention, the second internet document is substantially similar to the source internet document, further including the granular element associated information, and possibly changes required for the insertion of the granular element associated information. However, other types of second internet documents may also be implemented.

According to an embodiment of the invention, the generating of the second internet document includes stage 81 of generating the second internet document in response to metadata of at least one granular element.

For example, decision regarding the generation of the second internet document may depend on ranking of granular elements (absolute ranking or relative ranking), on number of comments by users, (e.g. added as granular element added information), on time of commenting, and so forth.

According to an embodiment of the invention, the second internet document includes granular elements of several source internet documents. According to an embodiment of the invention, the second internet document includes granular element associated information for several referenced granular elements, of one or more source internet documents (or not originating in source internet documents) and by one or more users (or computer generated).

As aforementioned, granular element associated information of several users may be used. According to an embodiment of the invention, method 10 further includes receiving from another web user additional granular element associated information that is associated with a referenced granular element that is selected in response to a selection of the other web user (e.g. another instance of stage 70 with another web user); wherein the generating of the second internet document includes generating the second internet document that includes the at least one referenced granular element, other granular elements, the granular element associated information and the additional granular element information.

According to an embodiment of the invention, the generating of the second internet document includes modifying a spatial relationship between two granular elements in order to insert the granular element associated information. It is noted that spatial relationships may include, for example, inserting an empty space in which the granular element associated information may be inserted. It is noted that other relationships between granular elements may also be modified—e.g. temporal relationship, or even causal relationships.

Stage 80 is conveniently followed by stage 90 of providing the second internet document over an internet connection. It is however noted that the second internet document may also be otherwise provided (e.g. to a display of a local computer, over a local network, stored at a memory, printed, etc.). According to an embodiment of the invention, stage 80 is followed by printing the second internet document by a printer.

According to an embodiment of the invention, method 10 includes transmitting the second internet document to a cellular device over a cellular telephony network, for displaying by the cellular device. It is noted that a user who uses a cellular phone, for example, may also edit and/or comment on documents, according to an embodiment of the invention, and not only receive information. According to other embodiments of the invention, other networks (either wireless, wired, or combined) may be used, and other types of end devices.

According to an embodiment of the invention, stage 90 includes providing the second internet document to the browser within browser module.

It is noted that, according to an embodiment of the invention, stage 90 of providing the second internet document includes providing the second internet document to another web user. That is, the associated information entered by a first user may be seen (along with other document components) by another user.

It should be noted that the generating and providing of the second internet document may be an on going process, in which one or more user modify an internet document and/or comment on it, and the editing of those users can be seen substantially at real time by other users. According to an embodiment of the invention, the generating of the second internet document includes keeping version information of the second internet document, wherein information of versions that were viewed and/or edited (by one or more users) at different times is stored and can be provided later (e.g. in fulture second internet documents).

It is noted that when merging visual marks (or other granular element associated information) during collaborative work, granular element associated information of some users may affect this of some other users, and the merge may be performed incrementally on granular parts of the content by multiple users.

According to an embodiment of the invention, the providing of the second internet document is responsive to a received query for the source internet document (e.g. as in stage 12) which is received via a browser-within-browser module, wherein the providing of the second internet document includes providing the second internet connection to the browser-within-browser module.

It is noted that at least some of the above disclosed stages may be carried out, according to an embodiment of the invention, in response to a query of a user (either the web user or another web user). It should be noted that method 10 may not necessarily be initiated by a user, e.g. as discussed below—it may also be triggered by detecting modification of the source internet document, in predefined interval, or according to other computer decision rules.

According to an embodiment of the invention, method 10 include stage 12 of receiving a query for the source internet document. According to an embodiment of the invention, the providing of the second internet document is responsive to a received query for the source internet document, and includes providing the second internet document instead of the source internet document.

It is noted that the receiving of the query may be followed by stage 20 of acquiring the source internet document (which may start the process discussed above), by stage 80 of generating the second internet document (e.g. if not already generated and/or if requires modifications in response to definitions of the querying user), by stage 90 of providing the second internet document instead of the source internet document (e.g. if the second internet document is ready for provision), or by intermediary stages of method 10.

According to an embodiment of the invention, method 10 further includes stage 13 of comparing, following the acquiring of the source internet document, at least one granular element of the source internet document to at least one granular element of a stored version of the source internet document which was acquired in a previous time. It is noted that the comparing may also be made to a non-divided or to a partially-divided previously stored internet document.

The comparing may be carried out, according to different embodiments of the invention, in response to a request of a user, in response to modification of other internet documents, periodical, and so forth.

If a result of the comparison is that the source internet document was changes, different actions can be carried out. According to an embodiment of the invention, the comparing is followed by stage 14 of updating a stored version of the second internet document by inserting at least one granular element of the source internet document that is not comprised in the stored version of the second internet document. It is noted that, according to an embodiment of the invention, stage 14 is part of stage 80 of generating the second internet document, but this is not necessarily so.

According to an embodiment of the invention, stage 14 is followed by stage 15 of selectively notifying a web user of the updating, in response to at least one notification rule. It is noted that, according to an embodiment of the invention, stage 15 is carried out when the acquiring of the source internet is carried out regardless of any user request, but this is not necessarily so.

Referring to an updating of internet documents, it is noted that according to different embodiments of the invention, an updating of metadata may also be regarded as updating of the document, and may result for example in updating other users. For example, users may wish to be informed when a ranking of a given granular element in their blog falls beneath a predefined rank.

According to an embodiment of the invention, a user may be notified that information referred by him before (by adding granular element associated information) has been modified (or even removed).

According to an embodiment of the invention, a user can define what changes in an internet document (either specific or not) may result in notifying him. According to an embodiment of the invention, a user can define modifications by what users (specifically or according to some rules) should be communicated to him.

According to an embodiment of the invention, instead of notifying the user (in such cases), a user can define that other operations will take place. The user, for example, can define automatic publication to blogs, forums, bookmarking sites, directories sites, social sites, search engines, and so forth.

According to an embodiment of the invention, method 10 includes stage 16 of notifying another user, following the generating of the second internet document, that granular element associated information was provided.

According to an embodiment of the invention, method 10 includes stage 17 of printing the second internet document, or at least a portion of which (which is different than the first internet document).

FIG. 4B illustrates stage 70, according to different embodiments of the invention.

According to an embodiment of the invention, stage 70 is followed by stage 71 of storing the granular element associated information (independently, or associated to the source internet document).

According to an embodiment of the invention, stage 70 includes stage 72 of storing associated information metadata which includes metadata pertaining to the web user, as discussed above.

According to an embodiment of the invention, stage 70 includes stage 73 of receiving additional granular element associated information from another web user, wherein the additional granular element associated information is associated with a referenced granular element which is selected in response to a selection of the other web user;

According to an embodiment of the invention, stage 70 includes stage 74 of receiving granular element associated information that is associated with a referenced Flash-based granular element.

According to an embodiment of the invention, stage 70 includes stage 75 of receiving granular element associated information that is associated with the referenced Flash-based granular element that is accessible only after a series of user inputs.

It is noted that granular elements may be of different types, e.g. Flash, HTML and PDF, and that not necessarily each granular element correspond to an accepted industry standard, or have a visible materialization.

According to an embodiment of the invention, stage 70 includes stage 76 of receiving the granular element associated information that is associated with empty space granular element, that defines space between other granular elements.

FIG. 4C illustrates stage 80 according to different embodiments of the invention.

According to an embodiment of the invention, stage 80 includes stage 82 of modifying a spatial relationship between two granular elements in order to insert the granular element associated information, e.g. as discussed above.

According to an embodiment of the invention, stage 80 includes stage 83 of including in the second internet document at least one granular elements retrieved from an internet document other than the source internet document, which is accessible via a frame of the source internet document.

According to an embodiment of the invention, stage 80 includes stage 84 of generating the second internet document in response to properties of a target recipient (either hardware, software, or firmware properties of a device, or user-definitions of a user). For example, such properties which may be taken into consideration are display abilities, user language, browser, etc.

Such generation may include transcoding some or all of the component of the second internet document to match to the target recipient, and so forth. It is noted that a single second internet document may be transcoded to different target recipient, and that the stage of transcoding may follow a preliminary generating of the second internet document.

For example, it is noted that some metadata of granular elements may be device specific, and may require dedicated processing in response to properties of the target recipient (e.g. different devices or media).

According to an embodiment of the invention, the transcoding includes transcoding the second internet document to be transmitted over a cellular telephony network to a cellular device, for displaying by the cellular device. It is noted that a user who uses a cellular phone, for example, may also edit and/or comment on documents, according to an embodiment of the invention, and not only receive information. According to other embodiments of the invention, other networks (either wireless, wired, or combined) may be used, and other types of end devices.

According to an embodiment of the invention, method 10 includes generating multiple second internet documents that pertains to the source internet document, wherein different second internet document use at least one shared granular element, for reducing data duplication.

According to an embodiment of the invention, a single source internet document may be processed into an array (or group) of several derived second internet documents, such as—for example: second internet documents with search-related metadata per search, second internet documents with update history, second internet documents with user comments from different users, second internet documents delivered to multiple client device, private and public second internet documents versions, and so forth.

Generating many second internet documents for a single source internet document may result in a lot of potential duplicated data. According to the teachings of the invention, the duplicated data is conveniently divided into granular elements, thus enabling an efficient managing of data to limit duplications.

According to an embodiment of the invention, the different second internet documents include different metadata pertaining to the shared granular element.

According to an embodiment of the invention, method 10 (and especially in relation to the generating of the multiple second internet documents) includes comparing a granular element of a second internet document, to a stored granular element that is used by another second internet document, and replacing duplicate granular elements.

According to an embodiment of the invention, method 10 includes matching and/or comparing granular elements of interest to granular elements available on proxy and replace duplicate granular elements, enabling computation load and duplicate storage reduction. In some embodiments, granular elements may be matched based on digital signature

According to different embodiments of the invention (some of which are discussed above), method 10 enables sharing of content associated information between many users, where user may create or modify content, as well as receive and evaluate content created by others.

Therefore, according to an embodiment of the invention, method 10 includes storing at least one scoring value for each of different users who provide granular content associated information, and handling the granular content associated information at least partially in response to a scoring of the contributing user.

For example, a user may receive scoring for adding content, may loose scoring for providing defective or abusing content, and so forth. A receiving user may choose, for example, to only be informed of granular element associated information provided by users of high ranking.

Different embodiments of the invention provide methods for improving the stability, availability and functionality of web page storage, marking and sharing. In some embodiments, the methods disclosed (as well as systems and computer program products) use browser-in-browser technology in order to provide advanced functions and consistent user experience.

According to an embodiment of the invention, the methods herein disclosed (among which is, according to an embodiment of the invention, method 10) combine the following operations: (1) smart web content storage and analysis, (2) graphical marking and (3) efficient sharing and reputation management.

Generally speaking, it is noted that while in this disclosure some details of different embodiments of the invention are offered in relation to HTML pages, it will be appreciated by one expert in the art that similar designs may be used for mobile browsers, IPTV browsers, video calls, and other such network applications.

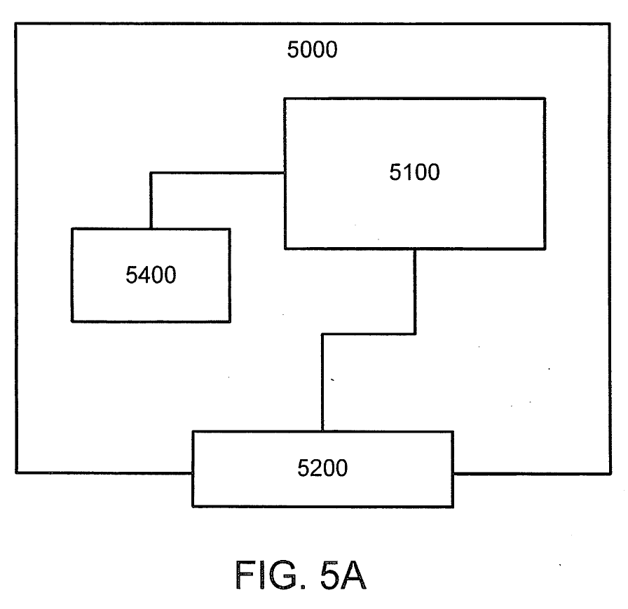

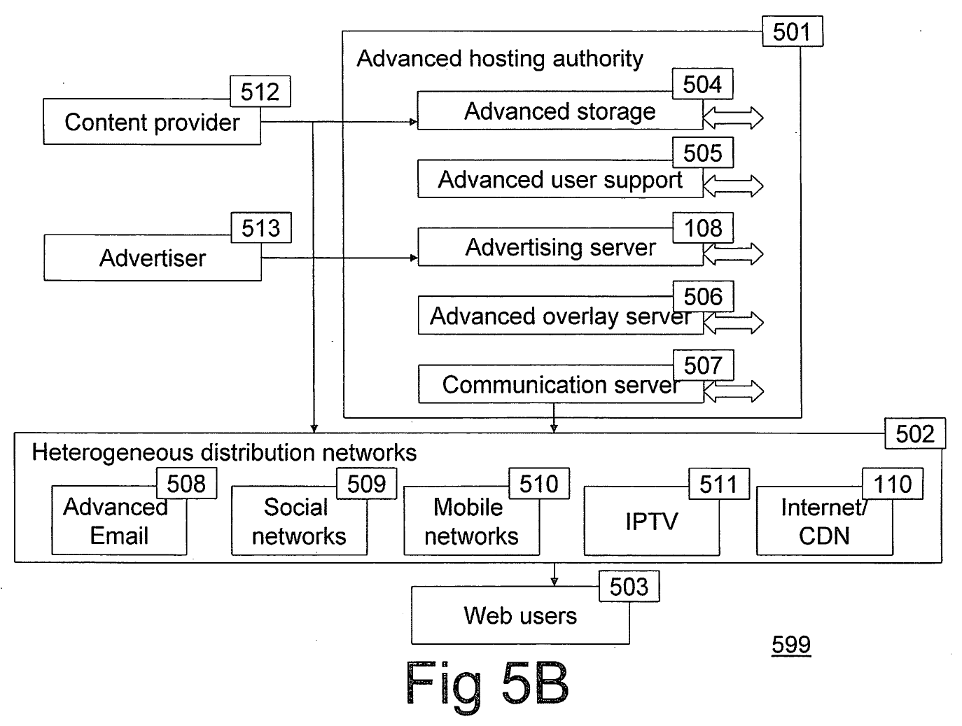

FIG. 5A illustrates system 5000 for managing content, according to an embodiment of the invention. It is noted that system 5000 is conveniently adapted to carry out method 10 (and possibly other methods herein disclosed), and that different embodiments of method 10 and other methods may be carried out by different embodiments of system 5000, mutatis mutandis, even if not explicitly elaborated.

System 5000 includes memory unit 5400 for storing at least one source internet document that has been acquired by system 5000 over an internet connection.

System 5000 further includes processor 5100 that is configured to divide the source internet document into multiple granular elements, and to provide a group of interrelated granular elements; and to add metadata fields to the granular elements; wherein processor 5100 is further configured to process granular element associated information that has been received from a web user (wherein the granular element associated information is associated with a referenced granular element that is selected in response to user selection) for generating, in response to metadata of at least one granular element, a second internet document that includes the referenced granular element, other granular elements, and the granular element associated information.

It is noted that, according to an embodiment of the invention, a spatial relationship may be defined for any granular element in respect to at least one other granular element. Processor 5100 is further configured to process granular element associated information that has been received from a web user, wherein the granular element associated information is associated with a referenced granular element that is selected in response to user selection, for generating a second internet document that includes the referenced granular element, other granular elements, and the granular element associated information.

System 5000 further includes interface 5200 for providing the second internet document (e.g. to a web-user, to another system, to a memory unit or a remote storage entity, to a printer, a display, and so forth). According to an embodiment of the invention, interface 5200 is configured to provide the second internet document over an internet connection.

According to an embodiment of the invention, interface 5200 is configured to provide the second internet document to another web user.

According to an embodiment of the invention, system 5000 (e.g. processor 5100, e.g. by interface 5200) is configured to provide a user interface for marking a portion of the source internet document, wherein the referenced granular element is at least partly referenced by a marking of the user.

According to an embodiment of the invention, processor 5100 is configured to generating, after the aforementioned dividing, at least one granular element in response to the marking of the user.

According to an embodiment of the invention, system 5000 (e.g. processor 5100 and/or memory unit 5400) is configured to record a marking of the user using spatial parameter responsive to a graphic display of a browser-within-browser module.

According to an embodiment of the invention, system 5000 (e.g. processor 5100 and/or interface 5200) is configured to provide the second internet document instead of the source internet document, in response to a received query for the source internet document.

According to an embodiment of the invention, memory unit 5400 is further for storing associated information metadata that includes metadata pertaining to the web user, wherein processor 5100 is further configured to generate the second internet document that includes at least part of the associated information metadata.

According to an embodiment of the invention, processor 5100 is further configured to process additional granular element associated information, which has been received from another web user, and which is associated with a referenced granular element that is selected in response to a selection of the other web user; and to generate the second internet document that includes the at least one referenced granular element, other granular elements, the granular element associated information and the additional granular element information.

Generally, it is noted that according to an embodiment of the invention, the generating of the second internet document includes generating the second internet document that further includes the additional granular element information that is added by one or more other web users.

According to an embodiment of the invention, processor 5100 is adapted to modify (usually upon need) a spatial relationship between two granular elements in order to insert the granular element associated information, for generating the second internet document.

According to an embodiment of the invention, processor 5100 is configured to compare, following an acquiring of the source internet document, at least one granular element of the source internet document to at least one granular element of a stored version of the source internet document which was acquired in a previous time, and to update during the generating of the second internet document a stored version of the second internet document by inserting at least one granular element of the source internet document that is not included in the stored version of the second internet document.

According to an embodiment of the invention, an acquiring of the source internet is carried out regardless of any user request, wherein the processor is configured to selectively notifying a web user of the updating, in response to at least one notification rule.

According to an embodiment of the invention, system 5000 (e.g. processor 5100 and/or interface 5200) is configured to notify another user, following the generating of the second internet document, that granular element associated information was provided.

According to an embodiment of the invention, the providing of the second internet document is responsive to a received query for the source internet document which is received via a browser-within-browser module, wherein the interface 5200 is configured to provide the second internet connection to the browser-within-browser module.

According to an embodiment of the invention, system 5000 (e.g. processor 5100) is configured to record (before the acquiring of the source internet document) a series of user inputs used by the user for reaching an internet document, wherein an acquiring of the source internet document includes repeating the series of user inputs for acquiring the source documents.

According to an embodiment of the invention, processor 5100 is configured to include in the second internet document, for the generating of the second internet document, at least one granular elements retrieved from an internet document other than the source internet document, which is accessible via a frame of the source internet document.

According to an embodiment of the invention, system 5000 is configured to receive (and processor 5100 is configured to process) granular element associated information that is associated with a referenced Flash-based granular element.

According to an embodiment of the invention, system 5000 is configured to receive (and processor 5100 is configured to process) granular element associated information that is associated with the referenced Flash-based granular element that is accessible only after a series of user inputs.

According to an embodiment of the invention, system 5000 is configured to receive (and processor 5100 is configured to process) granular element associated information that is associated with empty space granular element, that defines space between other granular elements.

FIG. 5B illustrates system 599 for managing content, according to an embodiment of the invention. It is noted that system 599 and 5000 may, according to some embodiments of the invention, execute similar functionalities, and that components of system 599 may be used mutatis mutandis in system 5000, and vice versa, even in not explicitly so elaborated.

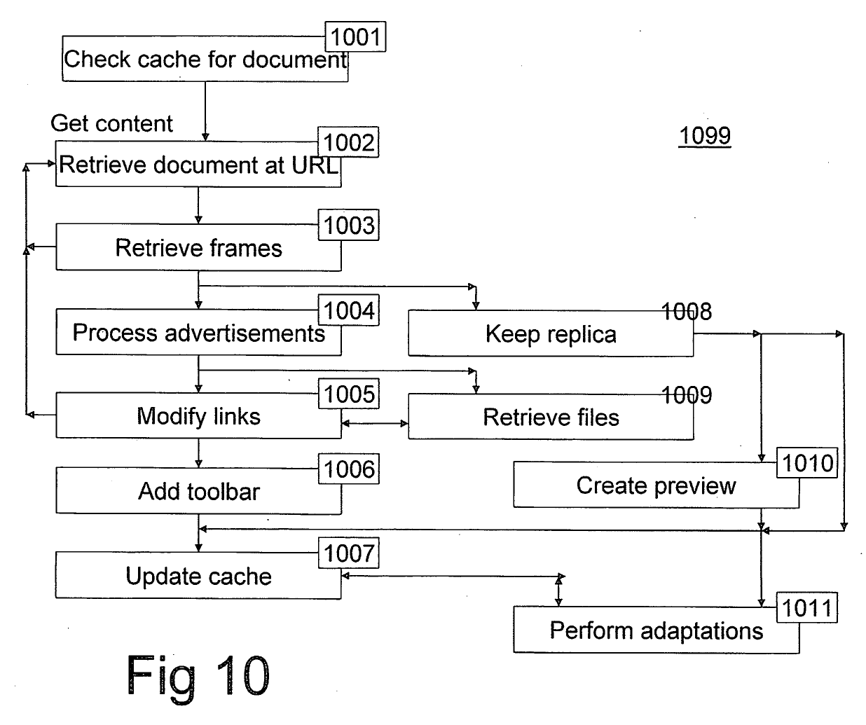

System 599 includes hosting authority 501 (also referred to as advanced hosting authority 501) which conveniently includes the suitable services and the communications within. According to an embodiment of the invention, advanced hosting authority 501 may utilize upload speeds lower than download speeds when using document storage on hosting authority. For example, according to an embodiment of the invention, hosting authority 501 (or a processor of the system) may modify links in the body of an internet document to point to the content on remote sites, which enables delegation of the download bandwidth requirements to the remote sites, e.g. as shown on FIG. 10.

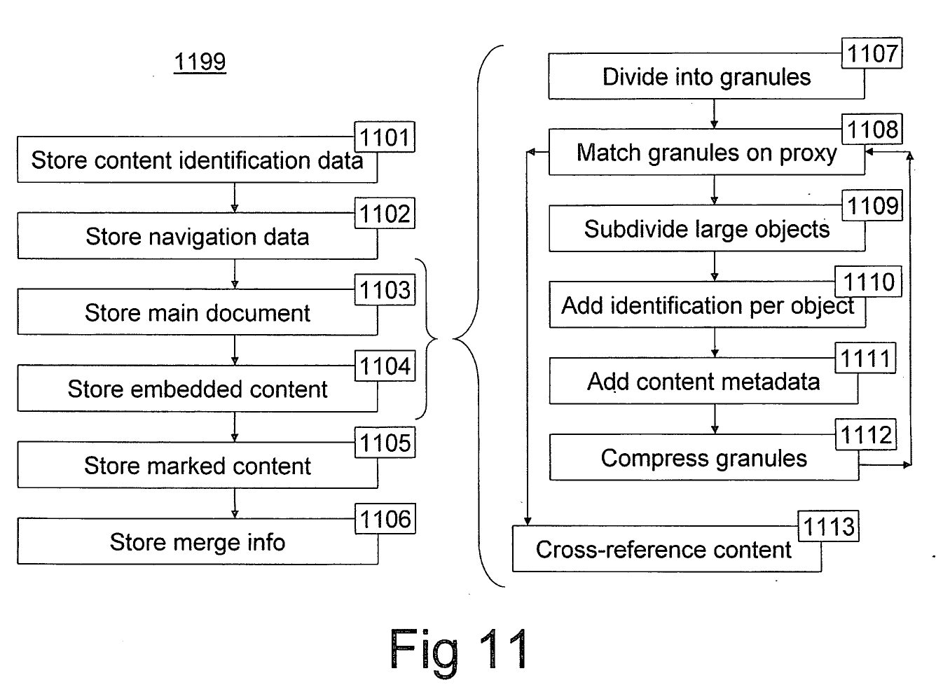

According to an embodiment of the invention, hosting authority 501 includes storage server 504 (also referred to as advanced storage server 504) which enables efficient content storage operations, including retrieval, modification and storage, granular proxy and compression of the content available from content provider 512 and associated sites, e.g. as illustrated in relation to FIG. 11, or any other suitable storage-related activities.

According to an embodiment of the invention, hosting authority 501 includes user support server 505 (also referred to as advanced user support server 505) which may include, for example, dedicated reputation management and visual content management modules, or any other suitable user management and CRM (customer relationship management) services.

According to an embodiment of the invention, hosting authority 501 includes overlay server 506 (also referred to as advanced overlay server 506) that may execute the algorithms that render visual mark on any part of the internet document (also referred to as web page) or any other suitable methods for vector graphics and rich media processing.

According to an embodiment of the invention, hosting authority 501 includes communication server 507 that may provide transcoding and routing services between heterogeneous distribution networks 502, including communication protocols support, encryption, error recovery, or any other suitable communication service.

It is noted that some or all of the functionalities of the aforementioned servers may be implemented, in other embodiments of the invention, by different architectures of one or more servers.

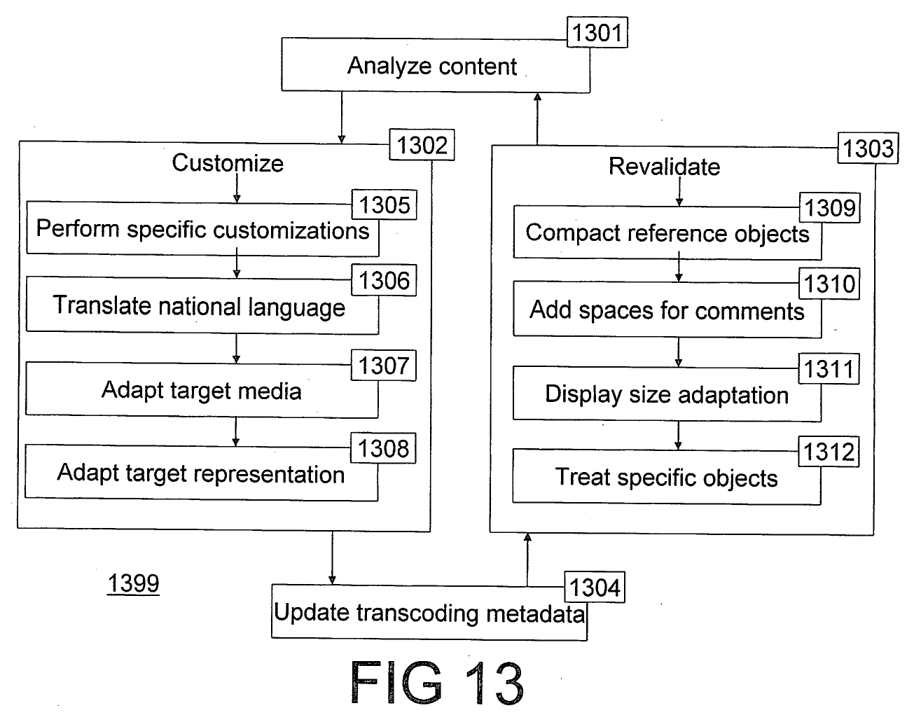

According to an embodiment of the invention, system 599 includes one or more distribution networks or interfaces, collectively denoted 502 (and also referred to as heterogeneous distribution networks 502), that enable distribution of content (such as the second internet document) for different types of devices, e.g. as illustrated in 503. The enablement may be embodied via dedicated transcoding and adaptation algorithms, including algorithms illustrated in relation to FIG. 13.

According to an embodiment of the invention, an advanced email interface 508 may communicate with e-mails, instant messaging or other suitable messaging service may rely on email 11 infrastructure or other suitable communication layer, and may include additional functionality, such as read receipt, spam-filtering, attachments or other suitable capabilities.

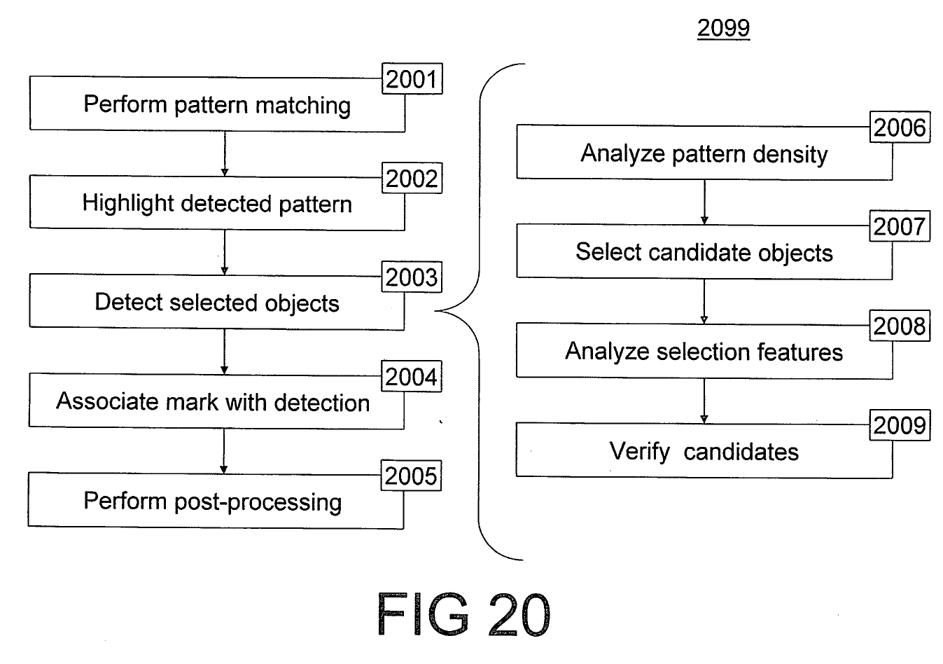

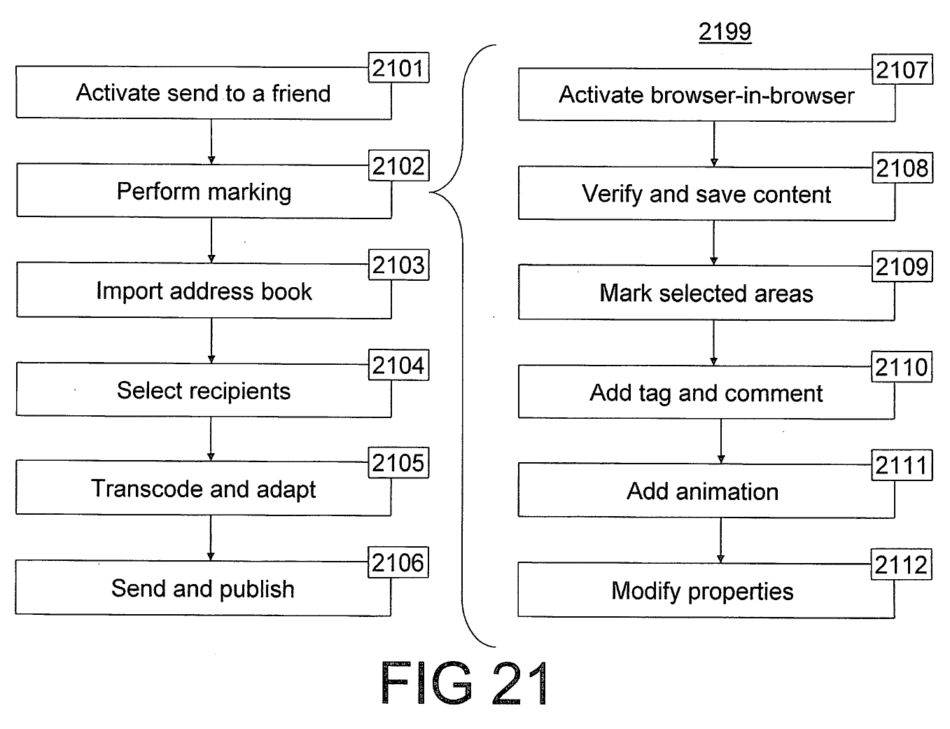

According to an embodiment of the invention, Social networks interface 509 may communicate with blogs, social bookmarking networks, professional and personal social networks, streams networks (Twitter™, Plaxo™), content exchange networks (Emule™, YouTube™), collaborative browsing networks, MMORG and virtual worlds (SecondLife™) and any other suitable social media. Communication of content objects with social networking may include open API (application programming interface), white label services, widgets or any other suitable interface. In some embodiments, “send to a friend” button of a blog or search capabilities of a portal may be used for activation of the invention, as illustrated in relation to FIG. 20-21.

According to an embodiment of the invention, mobile networks interface 510 may communicate with mobile web, video call, SMS, MMS and other services.

According to an embodiment of the invention, IPTV interface 511 may include with IPTV networks, including for example IPTV, web TV, mobile TV, or any other suitable device capable of reception and visual presentation of data.

It is noted that the web users (collectively denoted 503), are not necessarily only PC users, but may also be users of any web-enabled device, such as IPTV, mobile phone and other suitable device with internet or intranet access.

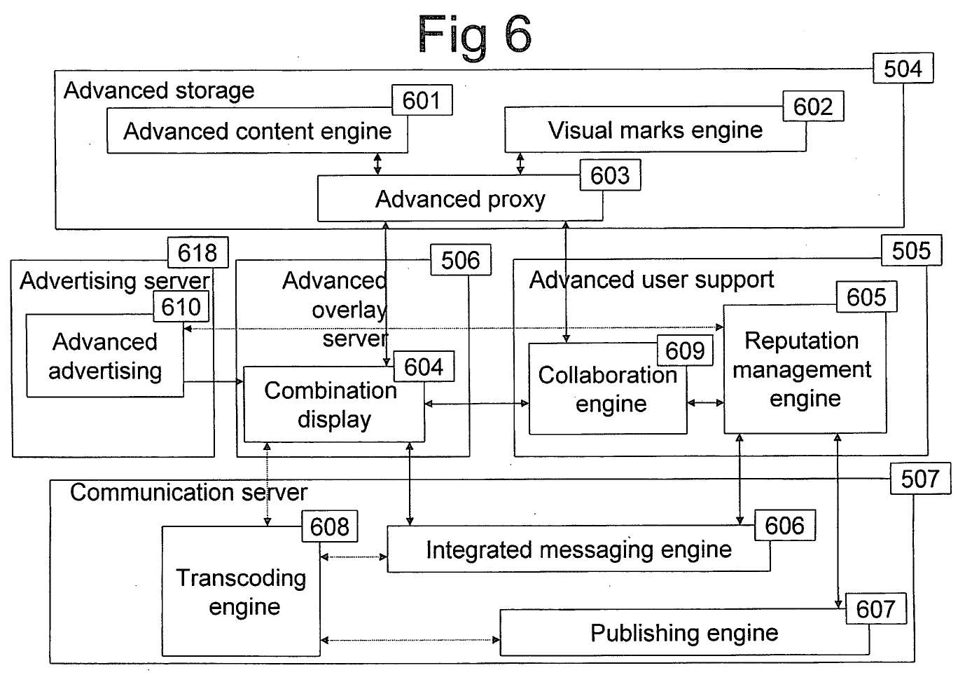

FIG. 6 illustrates different components of system 599 for content management, according to an embodiment of the invention.

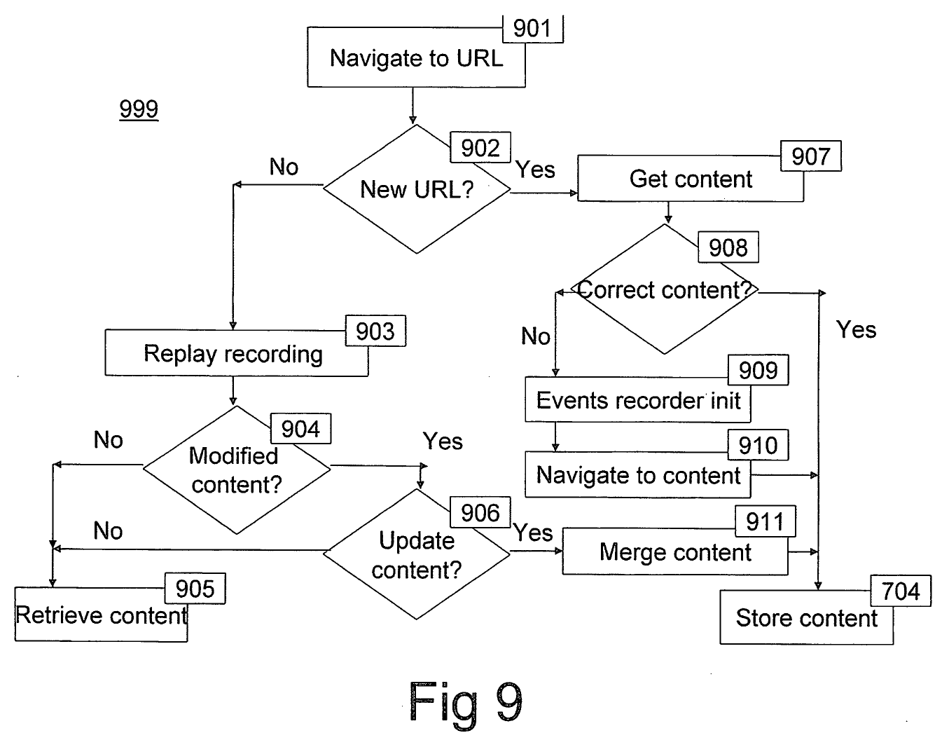

According to an embodiment of the invention, storage unit 504 (also referred to as memory unit 504, or advanced storage 504) includes content engine 601 (also referred to as advanced content engine 601) that may include, for example, content storage and browser-in-browser technology for content management, e.g. as shown in relation to FIG. 9. Content engine 601 conveniently enable high reliability for changing, dynamically generated and password protected content. Moreover, content engine 601 may offer smart compression and storage, e.g. as described in relation to FIG. 11.

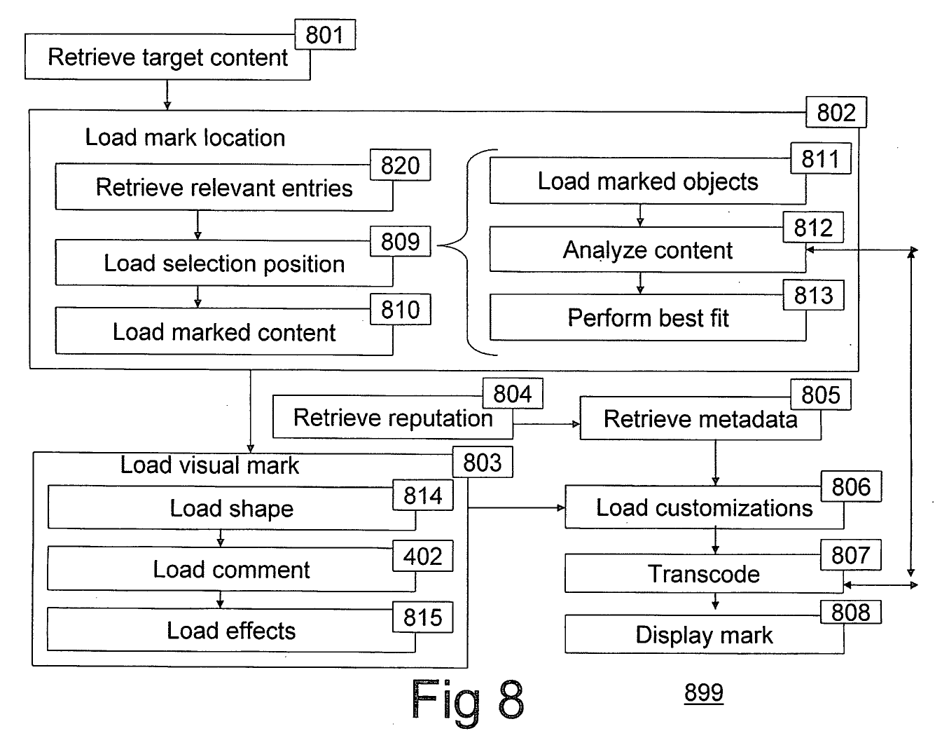

According to an embodiment of the invention, storage unit 504 includes visual marks engine 602 that may include functionalities similar to those of comment engine 202, and also may enable visual marking technology for user comments, e.g. as shown on FIG. 8. Visual marks engine 602 conveniently enables marking of text, images and image parts, video and animation and combination of thereof.

According to an embodiment of the invention, storage unit 504 includes proxy 603 (also referred to as advanced proxy 603) that may include functionalities similar to those of smart proxy 203 and additional functionalities, e.g. one or more functionalities of the following:
a. Browser-in-browser technology that enables monitoring user actions as user surfs through the proxy 603, enabling advanced scripting, statistics, contextual information, collaborative browsing and other suitable premium services. For example, the communication between advanced proxy 603 and collaboration engine 609 supports multiple users seeing each other marks at the same time.
b. Support of content management as described in relation to FIG. 9, enables handling of modified and protected content, version control, URL disambiguation, cross-site navigation or any other suitable services.
c. Contextual and behavioral advertising based on user data and on message reputation calculated by 605 or any other suitable data.

According to an embodiment of the invention, overlay server 506 includes combination display 604 that may include functionalities of overlay display 204, as well as one or more of the following extended functions:
a. Display of visual marks, including vector graphics, embedded rich media objects, active objects, adaptation to resize of the application window and other suitable functionality.
b. Handling events and animation effects, including event listeners, dynamic object properties, Flash objects, or any other suitable technologies.
c. Adaptation to target device, browser, language and customized settings enabled by transcoding engine 608.
d. Display of status of other users and feedback to other users enabled by collaboration engine 609.

According to an embodiment of the invention, user support server 505 includes reputation management engine 605 that provides different functionalities (such as those described below in relation to FIG. 10), including managing user reputation, managing content reputation, managing comment reputation, managing information handling based on reputation, promoting users, content and comments or performing any other suitable reputation management. For example, reputation management engine 605 may enable one or more of the following:

a. Filter messages according to user voting

b. Provide incentive for users to be proactive

c. Monetization of reputation

According to an embodiment of the invention, functionalities of sharing 205 may be distributed between specialized modules of integrated messaging engine 606 (of communication server 507) and publishing engine 607 (of communication server 507). Integrated messaging engine 606 and publishing engine 607 may include functionalities that do not exist in prior art component 205.

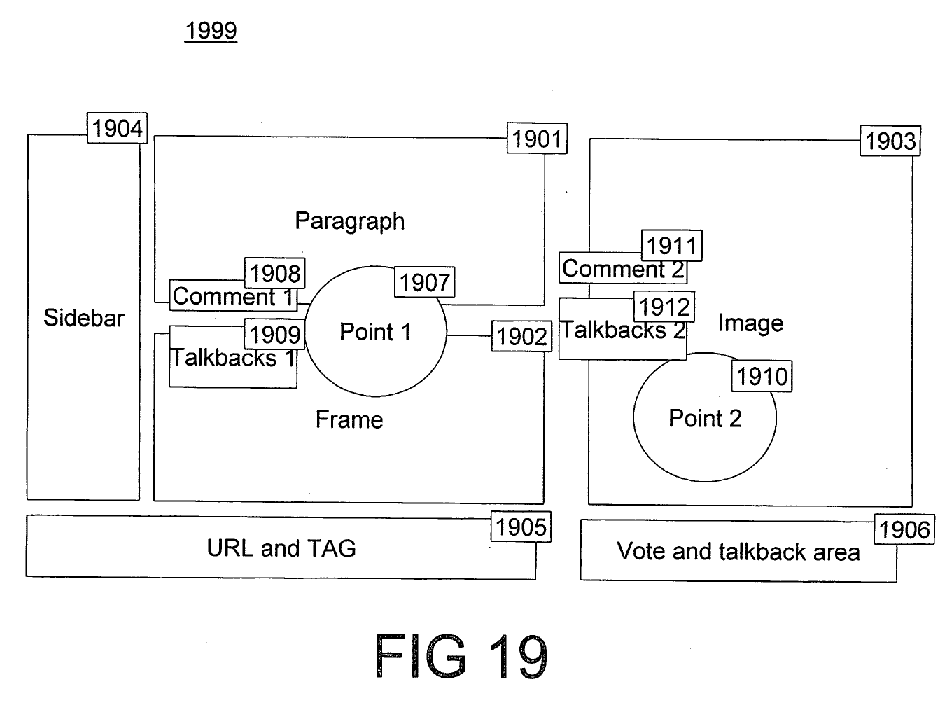

According to an embodiment of the invention, communication server 507 includes integrated messaging engine 606, that implements communication via multiple messaging services, including by way of illustration Email, SMS/MMS, instant messaging, video call. Messaging may be private or public via broadcasting media including by way of illustration RSS streams, video streams. The message may be automatically composed using templates. One template may serve various messaging media. One message may be based on multiple templates. An exemplary illustration of message with visual mark is given on FIG. 19. A number of messages sent by the user may depend by way of illustration on spam filtering settings, account settings, user reputation calculated by reputation management engine 505 or any other suitable governance policy. For example, the reputation management may serve as built-in anti-spam filtering, when recipients may vote for senders' reputation and senders' reputation may be monetized or used as a filter for communication capability.

According to an embodiment of the invention, communication server 507 includes publishing engine 607 that enables publishing capabilities, by way of illustration publishing into blogs, forums, bookmarking sites and directories, social sites, search engines, video exchange services or any suitable publicly accessible data depository. Publishing may be limited to a group or organization. In some embodiments, message reputation calculated by 605 may be used as a filter for publishing functions.

According to an embodiment of the invention, tagging is implemented by messaging engine 606 and publishing engine 607 and may have multiple functions in which. For example:
a. Tags may be used by integrated messaging engine 606 as a tag for bookmarking and social services. For example, in some embodiments, when a user publishes the content in Digg™ or Ma.gnolia™, the tag is exported automatically as a tag in the target social bookmarking service and does not require information reentry.
b. Tags may used by publishing engine 607 as a subject for emails and other messages. For example, in some embodiments, when a user sends an Email message to another user, the tag may appear in the subject of the mail. In some embodiments, the tag may appear as a title for the stored marked content document and/or image. In some embodiments, the tag may appear as a title for the message send to another user and/or as a name of a presentation document and/or title of a film sent to video sharing site. In some embodiments, the tag may appear in a content of SMS or other suitable message.
c. Tags may enable users to find marked content in advanced content engine 601, including by way of illustration directory or keyword search.

According to an embodiment of the invention, communication server 507 includes transcoding engine 608 which is configured to fit the message (e.g. the second internet document) to the target media and user specifications. Transcoding operations may include, by way of illustration:
a. Marked content to video transcoding for video call or video sharing.
b. National language transcoding from the source national language to the national language of recipient.
c. Marked content transcoding to multiple images or image slideshow for devices with limited rendering capabilities.
d. Computer language transcoding, including AJAX to Java adaptation.
e. Encryption for secure communication purposes.
f. Content customization including ad-blocking, hints and pointers to other users and sites, toolbar insertion.

According to an embodiment of the invention, user support 505 includes collaboration engine 609 that enables multiple users to collaborate while browsing, marking the web pages, and sharing content, such as by way of illustration:
a. Collaborative or simultaneous web browsing of multiple users or from multiple devices; collaborative or simultaneous web marking and comment writing; collaborative or simultaneous voting. In some embodiments, platform for exchanging comments, marks and recommendations may be supplied.
b. Version control, including baselines, labels, comparison and merging, parallel development streams, released content management and similar version control activities. For example, merging mark streams of multiple users into one stream.
c. Social networking platform, including platform for finding users with similar tastes and contextual advertising, import and export of information from other social networks and other suitable social activities.

According to an embodiment of the invention, system 599 includes advertising server 618 that may include, for example, advanced advertising unit 610 that may include advertising interface similar to 206 with additional capabilities such as adaptation between advertising cost and reputation score. Some embodiments may include revenue sharing business models.

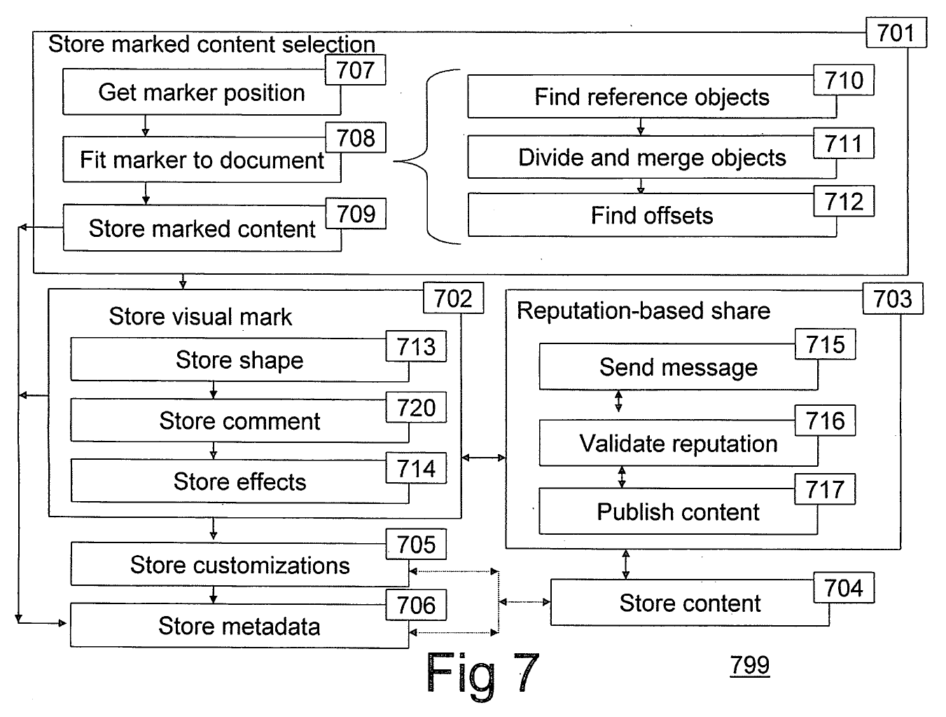

FIG. 7 illustrates method 799 for creating markers, according to an embodiment of the invention. It is noted that method 799 (or stages thereof) may be used for stage 50 of method 10, and vice versa.

According to an embodiment of the invention, method 799 starts with stage 701 of storing marked content selection. It is noted that the marking method may be based, according to different embodiments of the invention, on XML parsing methods (such as XPointer and XMark), as well as on reference objects with unique attributes.

For example, the content objects stored in stage 703 may be associated with unique identifiers, which may also be associated with visual marks. The collection of reference objects, with their identifiers, may be associated with the visual mark attributes, including location and size. Dynamically generated objects may not be stored with identifiers, in which case attributes of other objects, including by way of illustration parent object and next sibling object, may influence visual attributes of the mark. The content selection may also enable preview functionality. For example, visual representation, including by way of illustration thumbnail of the marked content and the mark, may be stored in stage 706.

According to different embodiments of the invention, stage 701 of storing the marked content selection may include one or more of stages 707-712.

Stage 707 includes Get marker position. The marker position may include document selection range or section or other suitable properties (e.g. as in stage 304). However, in some embodiments, the marker position may also be calculated in visual coordinates, including by way of illustration screen coordinates of mouse and coordinates of selected objects. For example, the marker position, may be calculated in form of top-left and bottom-right of the active object.

Stage 708 includes Fit marker to document, including translation from screen coordinates to document objects coordinates. In this stage multiple objects may be associated with a mark, enabling error resilience with dynamically generated objects.

It is noted that stage 708 may include, according to an embodiment of the invention, carrying out stages 710-712.

Stage 710 includes Find reference objects, which may either directly influenced by the mark or adjacent to influenced objects. The mark may be associated with on several levels of DOM tree. When some of the elements of DOM tree are modified, it may be possible to retract the mark position relative to other levels. The information of mark position may influence transcoding methods, since the area of the mark should stay intact under transcoding operations. A mark may also come not on a specific object, but relative to an object or group for objects, including by way of illustration after specific object or prior to specific object, which identification information may be stored with other mark information. Since each content object may stored with unique identification attribute, the object coordinates can be recalculated for visual marking purposes in any processing stage.

Step 711 includes Divide and merge objects. Visual mark may be associated with parts of objects, via offset coordinates, and it may also be associated with objects specifically generated for marking purposes. In some embodiments, the objects may be segregated into smaller objects or merged into larger objects, some objects may be encapsulated in layer or other DOM structure or subjected to other suitable modification mechanism.

For example, the reference objects may be divided into smaller objects in the following ways:
a. Text objects may be divided into words, where each word can be represented by e.g. span object.
b. Image objects may be represented as a table of image parts.
c. Spaces may be represented as multiple empty layer objects.

For example, the segregated objects may be merged back in clusters of:
a. Selected objects, representing the content selected by the user. The selected objects may be stored in step 712.
b. Unselected objects are objects that were not selected by user.
c. Spaces. Spaces allow fitting the shape of the visual mark and placing comments. The space objects may be allocated during object segregation. For example, the background relatively uniform areas of images may be used as placeholders. Alternatively spaces may be added between objects, such as spaces between paragraphs.

Stage 712 includes Find offsets. The mark position may appear in a given offset from the reference object. The offset computation may come in terms of any coordinate system, including by way of illustration character counting (XPoint mechanism) used with text in step 309, and also offset in pixels or inches, offset as percentage of object. Offset coordinates enable marking of parts of objects (images, video etc) and marking located relative to object. In some embodiments, the offsets include not only position on screen, but also temporal and event-driven information, including by way of illustration position in time and duration relatively to the event. Since offsets appear in several levels of DOM, the visual mark transcoding may be affected by marked objects, including preservation of content in a form close to the original marked by the user.

It is noted that in any stage during method 799, objects and/or groups of objects may be stored as granular elements.

Stage 701 conveniently continues with stage 709 of Store marked content. The marked content may be stored in multiple formats and instances, including by way of illustration:
a. Store as a document. The marked content may be encapsulated into HTML, RSS or other rich media format and may further be inserted into documents and templates.
b. Store as an image. A raster image, vector image, slideshow, animation, video or any other suitable graphical representation may be generated from the marked content and stored for further use. In some embodiments the image persists in several scales, such as full image, preview image and icon. In some embodiments the image is stored with the mark on it.
c. In some embodiments, multiple marks and marked content may be stored as slideshow or video. In some embodiments the slideshow may be exported to various slideshow viewers, such as Microsoft Powerpoint™ or Google Presentation™. In some embodiments the slideshow may be transcoded into flash or video formats.

Stage 701 is conveniently followed by stage 702 of storing the visual mark. It is noted that the storing of the visual mark may include storage of additional elements, as in one or more of stages 713, and 714, as well as storing comment (may be similar to stage 302).

Stage 713 includes Store shapes. The shapes may used to create desired visual effect on a certain part of the document/page. Various shapes may be used, including by way of illustration, circles, rectangles, arrows, symbols, highlights etc. In some embodiments shapes may be specifically designed for visual marking purposes. For example, the following guidelines may be used.
a. Partially-transparent shapes with wide line width may be concentrate user intention while enabling visualization of underlying content.
b. Shapes with no fill enable simple execution of underlying hyperlinks. Shapes with fill may require modification of underlying content.
c. Handwriting imitation may be more visible that geometric shapes and standard fonts and may provide recipient with personal “done-by-human” feeling.

Handwriting imitation may include, for example, the following methods:
a. Instead of perfect closed circles and rectangles use imperfect spiral-like shapes. For example, such shapes may be generated via several arc and line segments.
b. Introduce small hand tremble via random noise generator. For example, introduce random noise to position of line and arc segments start and end points.

Stage 714 includes Store effects, such as animation and events. The effects and events may be used to coordinate timing and appearance of marks with user actions and improve the visual effect of the resulting presentation. The effects include by way of illustration:
a. Fade in/fade out of visual mark
b. Sliding visual mark
c. Audio accompaniment for visual mark
d. Color changing visual mark

The events may include by way of illustration:
a. Mouse hovering above some area
b. Mouse clicking above some area
c. Page load
d. Timer from other event

According to an embodiment of the invention, method 799 further includes stage 703 of managing sharing of content according to reputation, which may be carried out before, after, or in parallel to stage 702, according to several embodiments of the invention. In addition to generally used share methods, reputation engine interface may be used. User profile, amount and form of communication, group security and privacy and other suitable parameters may depend on web reputation. In some embodiments, the proposed system may utilize communication via external messaging and publishing services. In some embodiments the proposed system is equipped with internal messaging and publishing capabilities.

It is noted that according to different embodiments of the invention, stage 703 may include one or more of stages 715-717.

Stage 715 includes Send message to limited mail-list, for example using an integrated messaging engine (e.g. using integrated messaging engine 606). The message may be sent via various communication mechanisms, including by way of illustration Email, SMS/MMS, instant messaging etc. The recipients' reaction, including by way of illustration page viewing and voting, may be used to validate the reputation (Stage 716) score and make decisions regarding the message. In some embodiments, recipients may act as moderators of message quality.

In some embodiments the allowed size of the mailing list depends on message reputation. With time and increasing message reputation, the message may propagate to additional users in the mailing list. This design enables users send messages to multiple other users, with built-in spam filtering mechanisms. Irrelevant messages may be detected by moderators (first to receive the email) and not sent to additional recipients. In some embodiments the user may send message to multiple recipients and pay a deposit as a guarantee for message quality.

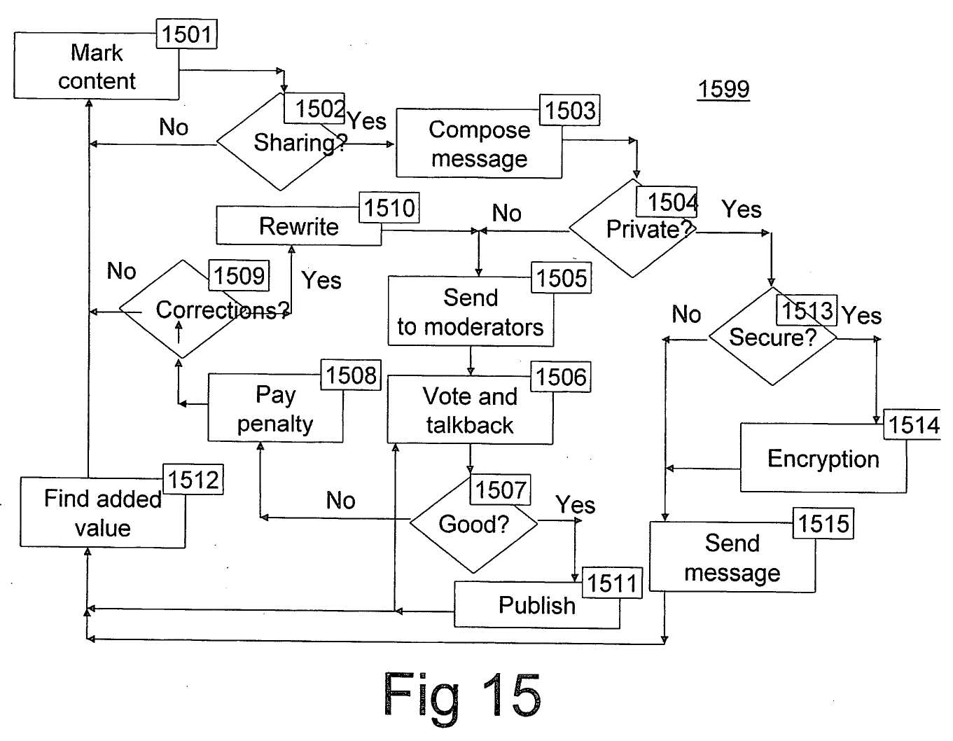

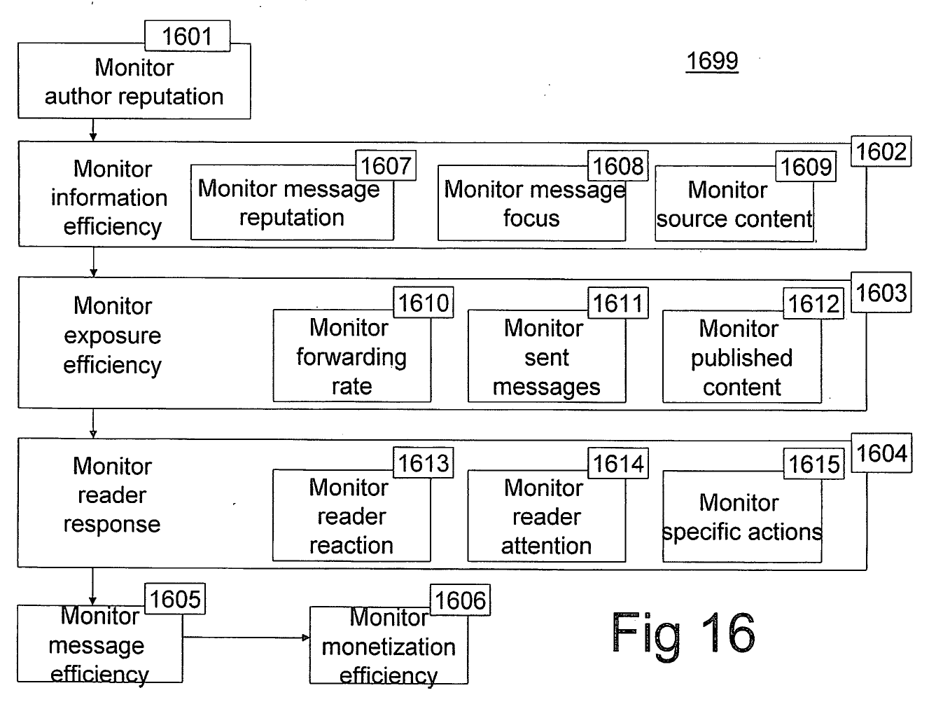

Stage 716 includes Validate reputation, including set of decisions based on reputation and hosting authority policy. In some embodiments, only messages with high reputations may be sent to large mailing lists. In some embodiments, only markings with high reputation may be published. In some embodiments, high-reputation messages may generate monetized benefit to the sender. In some embodiments, the reputation of the author may appear alongside the author name and the tag, enabling other readers to concentrate on messages from authors with given reputation. An embodiment of reputation validation method is illustrated in relation to FIG. 15 and FIG. 16.

Stage 717 includes Publish content, for example using publishing engine (e.g. publishing engine 607). The content (e.g. granular element associated information, a user comment) may be published manually or automatically in a variety of bookmarking sites, searching engines, social sites or other suitable media. In some embodiments the content may be published in protected media, including corporate portals and paid information portals. In some embodiments the published material may be available only to some group of user. In some embodiment publishing may be conditioned by marking, content or author reputation or other suitable policies.

According to an embodiment of the invention, method 799 further includes Stage 704 of storing content, for example including set of rules and decisions (e.g. as further described in relation to FIG. 11). Stage 704 conveniently enables sharing of dynamically generated or protected content or any other suitable content with limited availability.

According to an embodiment of the invention, method 799 further includes stage 705 of storing customizations, including set of rules and decisions (e.g. as further described in relation to FIG. 13). Stage 705 conveniently enables transcoding, content adaptation, customized GUI and other suitable customization mechanisms.

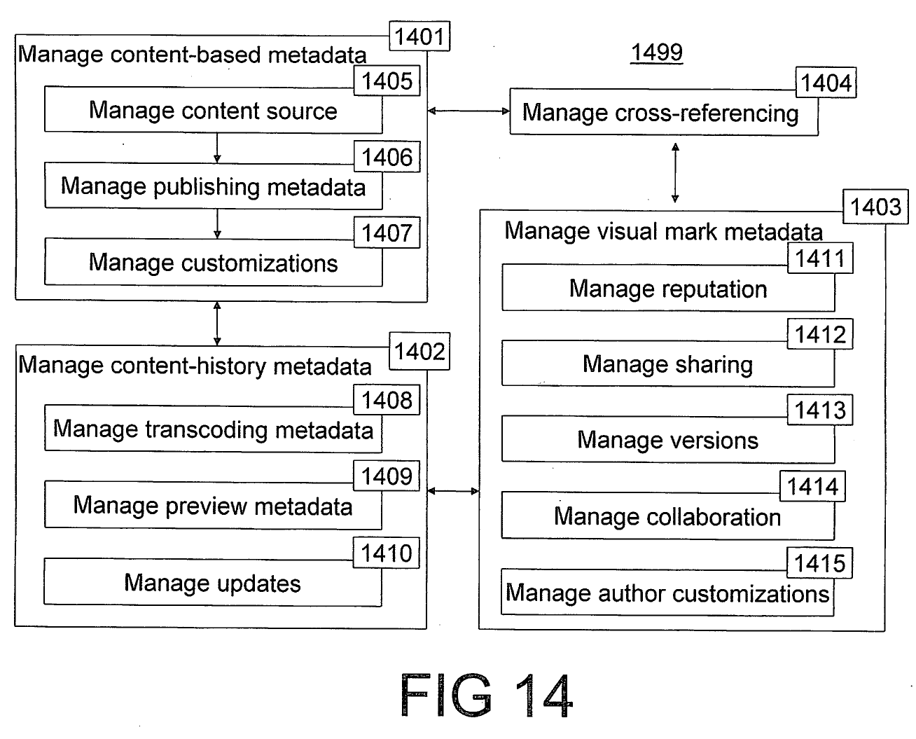

According to an embodiment of the invention, method 799 further includes stage 706 of storing metadata, including set of rules and decisions (e.g. as further described in relation to FIG. 14). Stage 706 conveniently enables fast preview and search, tag insertion, signature insertion, search engine optimization and other suitable services.

FIG. 8 illustrates method 899 for marker retrieval, according to an embodiment of the invention. According to several embodiments of the invention, the mark may be retrieved, by way of example, for display, user reaction and sharing or any other suitable operation.

It is noted that method 899 may be implemented mutatis mutandis for retrieval of other types of granular element associated information, according to different embodiments of the invention.

It is noted that the retrieval of the marking, and/or of granular elements associated with which, may be implemented by way of example as part of generating the second internet document (e.g. stage 80 of method 10), or as a preliminary stage for that generating.

Method 899 conveniently starts with stage 801 of retrieving target content, which may include, according to an embodiment of the invention, retrieving of series of validation and decision operations for retrieving the content from the target URL (e.g. as described in relation to FIG. 9).

According to an embodiment of the invention, stage 801 is followed by stage 802 of loading a mark location (usually of a user generated mark, but may also be of a computer generated mark). It is noted that according to an embodiment of the invention, the mark location may include the functionalities similar to those of 401, and may be given in terms of referenced sections and offset coordinates as described in relation to stages 809-813 and 820, one or more of which may be implemented as part of stage 802, according to different embodiments of the invention.

It is noted that stage 820 includes retrieving of relevant entries from a database, e.g. using username, URL, tag and other suitable identification information. It is noted that stage 820 may include retrieving processing and displaying multiple entries for an internet document (e.g. web page) of interest. Stage 820 may be similar, according to an embodiment of the invention, to the aforementioned stage 404.

Stage 809 includes Load selection position. Since the marker position may be stored in coordinates of selected objects the following steps may be executed:

According to an embodiment of the invention, stage 809 may include carrying out stages 811-813. Stage 811 includes Load marked objects. In some embodiments, the identification tags of marked objects may stored in a database and enable easy association between the attributes of marked objects and the objects stored as content. In some embodiments marked objects may appear as spatial clusters that may require additional validation and correction steps.

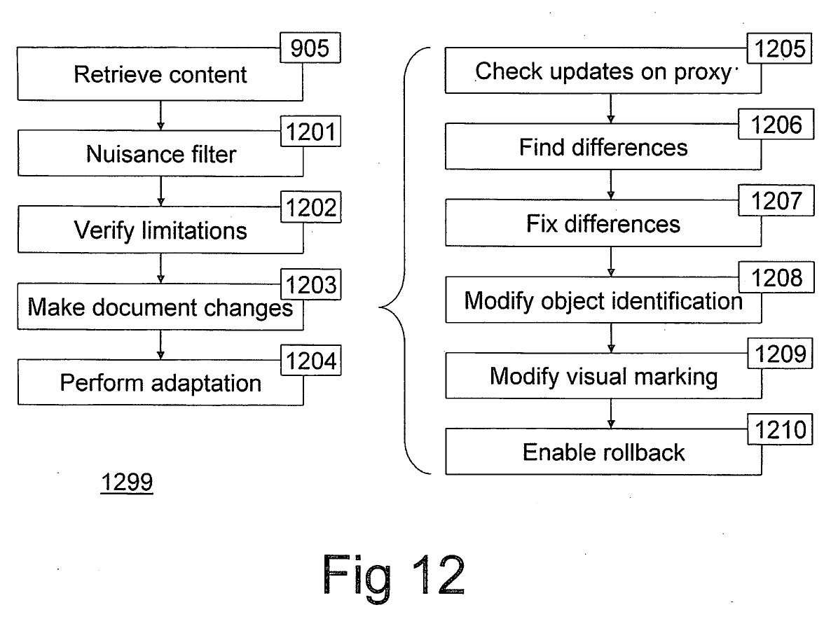

Stage 812 includes Analyze marked objects. Due to transcoding, dynamic content generation or other content modifications, objects that were previously clustered may become detached. It may be possible to cluster back detached objects by introducing corrective steps, including introduction of additional layers, insertion of white spaces, browser-executed scripts for grouping the objects or any other suitable mechanism. In some embodiments, dynamically generated objects may not preserve identification attributes and related objects may be used for reconstruction of the attribute. In some embodiments, the content may be modified (e.g. as depicted in relation to FIG. 12), and the marker offsets may also be modified. The required decisions may be made by decision system in step 812.

Stage 813 includes Perform best fit, including drawing visual mark that may be similar to the mark by the user, but may also correspond to the marked objects and offset values from stage 812. The visual attributes of the mark may be determined with respect to the mark shape, marked objects, offset values, user preferences or other suitable parameters.

Stage 810 includes Load marked content. The marked content may be stored in step 709 and may differ from the content retrieved in step 801. The marked content may require update operations to reflect the modifications in the original content.

According to an embodiment of the invention, method 899 further includes stage 803 of loading the visual marks.

According to an embodiment of the invention, stage 803 includes stage 830 of loading granular element associated information (such as a user comment; it is noted that the term comment is used, it could be extended, according to different embodiments of the invention, to other, granular element associated information). The details of the element associated information may be loaded and displayed, including public comments (or other element associated information) from other users to the content of interest. Stage 830 may include loading tag, including multiple tags, keywords and other suitable classification information; loading comment text, including plain text or rich text formats; loading attachments, including images and icons; loading pointer to next comment when there are multiple ordered comments; and so forth.

According to an embodiment of the invention, stage 803 includes stage 814 of loading a previously stored shape (e.g. a shape that was stored in 713), including shapes, images, dynamically generated visual objects, or other suitable visual representation or code to generate the visual representation. For example, is some embodiments, loaded shape may include placeholder for user voting, which may be represented by images that are dynamically generated based on user voting statistics.

According to an embodiment of the invention, stage 814 may include loading events and effects that were previously stored (e.g. at stage 714), including dynamic generation of new effects based on stored templates and updated statistics.

According to an embodiment of the invention, the displaying of marks (or of other granular element associated information) may be responsive to a reputation of a user who loaded that granular element associated information (or to other user related parameters, e.g. geographic location, etc.). According to an embodiment of the invention, the displaying of marks (or of other granular element associated information) may be responsive to a reputation who is not associated with a single user, e.g. with content, comments, groups of users, groups of content sources, comments on already commented content or other suitable entities.

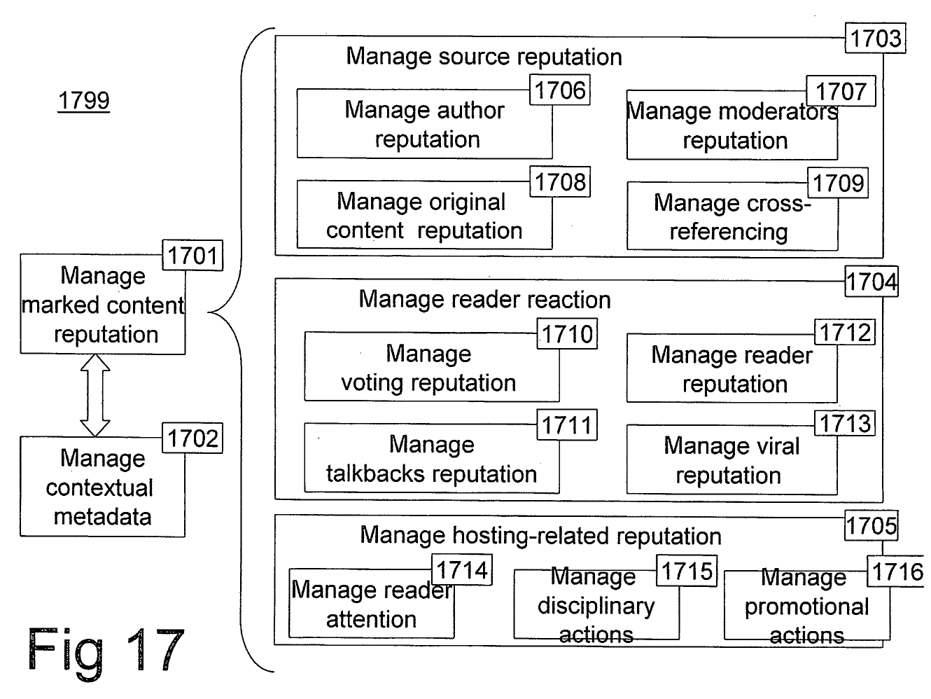

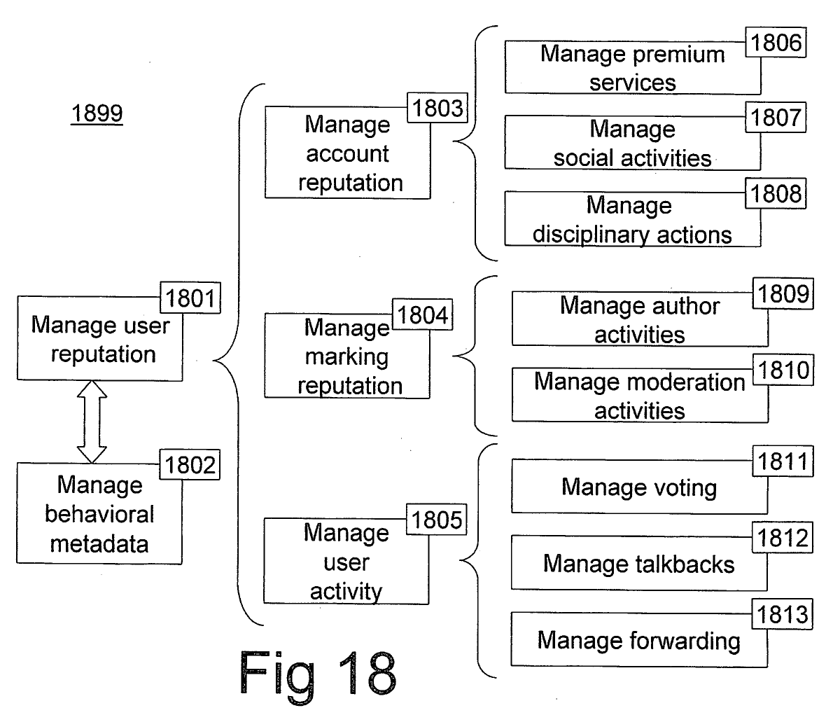

According to an embodiment of the invention, method 899 includes stage 804 of retrieving reputation. The reputation may be associated with users, content, comments, groups of users, groups of content sources, comments on already commented content or other suitable entities. The reputation may be added to metadata in stage 805. The reputation results may be updated, based on user voting, feedbacks, hosting authority actions or other suitable statistics (e.g. as illustrated in relation to FIGS. 17-18).

According to an embodiment of the invention, method 899 includes stage 805 of retrieving metadata. The metadata may be used, by way of example, to one or more of the following: for reputation-based share 703, display of the mark 808, promotion of the content in search engines and advertising networks, search of the content via keywords or in directory, or any other suitable application.

According to an embodiment of the invention, method 899 includes stage 806 of loading customizations, which may follow (and/or be responsive to results) of one or both of stage 803, 804, and 805. The customizations may be added to the mark data, marked content, stored metadata or any other suitable data structure and may influence suitable decision-based methods, including by way of illustration the transcoding 807 stage.

According to an embodiment of the invention, method 899 further includes stage 807 of transcoding (the mark, the granular element associated information), e.g. for a target device, user profile, representation form, or other suitable specification, including decision-based data adaptation process (e.g. as illustrated in relation to FIG. 13).

According to an embodiment of the invention, method 899 further includes stage 808 of display the mark. It is noted that, according to embodiments of the invention, the mark display may involve multiple objects and decision processes, (e.g. as described in stages 801-807 and/or as illustrated in relation to FIG. 19).

FIG. 9 illustrates method 999 for managing content, according to an embodiment of the invention. It is noted that According to an embodiment of the invention, method 999 includes stage 801 of retrieving target content.

It is noted that, according to an embodiment of the invention, method 999 may be implemented as part of method 10.

Conveniently, method 999 starts with stage 901 of receiving a query for the source internet document (e.g. attempt to navigate to URL), including by way of illustration, activation of dedicated GUI and display of the URL information as it is visible to the remote proxy. The URL in advanced proxy 603 may be set to the value provided by the user or associated URL provided by database entry, or any other suitable URL. In some embodiments, dedicated browser-in-browser mode is activated. The browser-in-browse mode includes user performing browsing operations through the GUI provided by advanced proxy 603. In some embodiments, the browser-in-browser mode may enable record and replay of user actions in 903, 909, 910.

Stage 910 is conveniently followed by stage 902 of determining whether the source internet document queried has been previously acquired (e.g. if it is a new URL). According to an embodiment of the invention, stage 902 includes verifying that URL does not appear in databases of stored content. When the URL is entered for new content, execute stage 907, otherwise execute stage 903. The query may be performed on advanced content engine 601. In some embodiments the query may be performed in several steps. For example, the advanced proxy short-term cache maintained in steps and 1007 may be tested first. In case of “miss” in short-term cache a query is performed on a long-term storage.

According to an embodiment of the invention, if the source internet document have been acquired before, stage 903 is carried out, wherein stage 903 includes replaying recording of operations (similar to stage 21). According to an embodiment of the invention, stage 903 includes repeating user operations, computer scripts or other suitable information. In some embodiments, navigation to the correct content may be performed in browser-in-browser mode, using recoding of user actions from 910. In some embodiments, the navigation may be performed automatically and remotely, using webcrawler robot activated on advanced proxy 603. It is noted that the queried internet document does not necessarily requires repeating of user operations for acquiring.

Stage 903 (or 902 if 903 is not carried out) is followed by stage 904 of comparing the a content of the source internet document have been modified (possibly similar to stage 13). According to an embodiment of the invention, stage 904 includes checking if the content was modified with respect to the content replicas stored in the database during step 1008. In some embodiments, multiple replicas of content associated with original content modification stages may be stored on the advanced proxy 603. The user may choose to update the content or to leave the content unchanged. If the content was modified or the content was not stored, execute stage 906, otherwise retrieve stored content replica in stage 905.

In case the content was not substantially modified (according to one or more decision rules), stage 905 is carried out, wherein stage 905 includes retrieve content replica already stored on remote server (e.g. the source internet document, the second internet document, and/or granular elements of any of those documents). The content may be already preprocessed for further manipulations (e.g. as illustrated in relation to FIG. 10), or may require some processing (e.g. as illustrated in relation to FIG. 10). Multiple users may share one replica of stored content. In some embodiments the content may be stored in encrypted or compressed form and decryption or decompression may be required.

According to an embodiment of the invention, if the content have been modified, stage 906 is carried out, wherein stage 906 includes determining whether to update the stored content, including by way of illustration, asking the user whether or not the content should be updated. If the content should not be updated, retrieve content replica in stage 905, otherwise update and merge content in stage 911.

Referring again to stage 902, if the source internet document queried has not been previously acquired (or a valid version of which is not available for retrieval), stage 907 is conveniently carried out, wherein stage 907 includes acquiring content (usually, similar to stage 20, acquiring the source internet document). According to an embodiment of the invention, stage 907 includes downloading content from the specified URL to remote proxy for further processing. Since the browser-in-browser mode may be activated in stage 901, the user may validate that the content corresponds to the content intended by the user for storage and marking.

According to an embodiment of the invention, method 999 includes stage 908 of analyzing the content (e.g. the source internet document) to determine whether a correction of the content is required. According to an embodiment of the invention, stge 908 includes verification that no additional corrective steps may be required. In some embodiments, the user may verify that the content seen within browser-in-browser mode matches the content selected for storage and marking. In case the URL content corresponds to what the user expects to see, store content in stage 703. Otherwise, enable user to execute corrective steps and record user actions via stages 909 and 910.

Stage 909 includes initializing an events recorder initialization, that may be used to activate recording of corrective actions taken by user in order to retrieve the proper content. The event recorder may be implemented as a module on advanced proxy 603 that enables record and replay user actions. In some embodiments, the event recorder may enable disambiguation of URL and password entry. In some embodiments, the event recording may be accompanied by single-sign-on solutions. In some embodiments, the event recording may be disabled for user privacy.

According to an embodiment of the invention, stage 910 includes receiving user corrections and/or user corrective actions, e.g. including navigation to proper content and user actions may recorded to enable replay. This step may be interactive, and may enable for human interface in browser-in-browser fashion. In some embodiments, the intermediate content and the objects from the user's entry coordinates may be translated into the proxy coordinates and stored for future replay.

Referring again to stage 906, method 999 may include stage 911 of merging content, in case of modified content. The identification attributes already existing on the objects may be preserved, and additional attributes may be distributed for modified and inserted content. In some embodiments, the clustering 808 operation may be performed to cluster modified content together with the original content.

Method 999 conveniently concludes, if a new content have been acquired, with stage 704 of storing content.

FIG. 10 illustrates method 1099 for retrieving content, according to an embodiment of the invention. Method may be carried out, for example, for stage 905, 907, and 20. It is noted that the content of method 1099 may be, for example, the source internet document, portions of which, granular elements of which, and/or portions of other documents.

Method 1099 conveniently starts with stage 1001: Check cache for document, including short-term cache query using URL or other suitable metadata on one or multiple proxies. Using documents cached on proxies may reduce computational load of processing and storage operations. The advanced storage server 504, may be distributed over multiple computers and utilize multiple storage and caching systems. In some embodiments, granular proxies which implement some elements illustrated on FIG. 11 may also be used for stage 1001.

Stage 1002: Retrieve document at URL or other suitable recourse location, including utilizing some remote file access method and partial or full document download from the given URL. In some embodiments, the mirror site of the content provider may be selected in a form that optimizes download speed or other suitable criteria.

Stage 1003: Retrieve frames. Frames, flash applications, SVG or other suitable complex content may be embedded inside a document. Frame's hierarchy may not be accessible from the main document due to limitations, including by way of illustration cross-site scripting security criteria. In some embodiments, retrieval and monitoring of documents embedded in frames of the main document may be enabled by moving the browsing activity to the browser-in-browser technology as illustrated in 910. The objects and documents embedded in frames may be treated in a similar way to the main document, including the operations illustrated in relation to FIG. 10.

Stage 1004: Process advertisement, pop-ups and other suitable dynamically generated content. In some embodiments, dedicated processing may be required for various advertisement scripts so that the advertisements revenues may be distributed properly between the content creator and the hosting authority. In some embodiments, ad-blocking algorithms may be activated, which may remove or otherwise modify suitable types of dynamically generated content.

Stage 1005: Modify links, hyperlinks and other suitable redirection objects. Images, video, Flash, style sheets, scripts and other active objects may be embedded in the main document. When main document has been stored on the hosting authority, the links may be modified for specific purposes, including by way of illustration bandwidth consumption optimization. For example, the links may be modified from relative to absolute path, so that download may be processed by the original content network and not the content network of hosting authority, resulting in hosting authority with higher download requirements than upload requirements. In some embodiments, multiple replicas of stored documents may reference single replica of embedded objects.

Stage 1006: Add toolbar, including control and display areas for content manipulation and monitoring. The toolbar may contain personal profile details, content details, tools for marking and voting, advertisement and other suitable GUI mechanisms. The toolbar may be added to the main document and/or other relevant documents and objects. In some embodiments, the toolbar may be implemented via event listeners added to objects in the document.

Stage 1007: Update cache including caching of processed document, unprocessed replica, processing metadata, objects of document, or any other suitable content representation. In some embodiments, multiple levels of caching may be used. For example, all relevant content may be stored on specific proxy, and digital fingerprint of the document may be stored on other proxies. In some embodiments, disambiguation of digital fingerprint may be used, enabling removal of redundant content replicas. For example, users with outdated replica of the content may be asked to update their versions when the original content is modified.

Stage 1008: Keep replica of the document in unprocessed or partially processed form, enabling document comparison, incremental updates, troubleshooting and other suitable content manipulations.

Stage 1009: Retrieve files, including objects referenced via links in the main document. The retrieved objects may be stored on advanced storage server 504. In some embodiments, the retrieved files may be modified during some content manipulations, including by way of illustration, overlay with user marks during transcoding.

Stage 1010: Create preview version of the original document, including by way of illustration, thumbnail image, tags and other suitable metadata. In some embodiments, preview document, image or file corresponding to the whole document may be generated. For example, the review information may include a thumbnail of the area of the document available to the user upon arrival to URL, content favicon, titles and date.

Stage 1011: Perform adaptations and transcoding including methods illustrated in relation to FIG. 13. In some embodiments, national language adaptations, device adaptation or computer language adaptations may be performed. In some embodiments adaptations scope may be restricted, by way of illustration to preview information and processed information. The adaptations may also be kept in cache.

FIG. 11 illustrates method 1199 for storing content, According to an embodiment of the invention. Method 1199 may be used, for example, in stage 704, or following stage 20. It is noted that the content of method 1199 may be, for example, the source internet document, portions of which, granular elements of which, and/or portions of other documents.

According to an embodiment of the invention, method 1199 starts (or otherwise includes) stage 1101 of storing content identification data, including by way of illustration URL, date and time, author of the marking, tag. The content identification data may be used for retrieving data from proxy in stages 404, 902 and 1001, content search or any other suitable content operation.

According to an embodiment of the invention, method 1199 further includes stage 1102 of storing navigation data, e.g. including navigation operations and corrective actions that enable navigation from the original URL to the required content, as addressed by 910, 909 and 903.

Method 1199 includes stage 1103 of storing main document (e.g. source internet document). According to an embodiment of the invention, stage 1103 (together or separately of stage 1104), includes stages 1107-1113. It is noted that some or all of the stages 1107-1113 may be incorporated as part of stage 30 of method 10.

Stage 1107 includes dividing the original document into granular elements (also referred to as granules), where granular elements may represent, for example, objects, groups of objects or output of any suitable segmentation algorithm. It is noted that according to an embodiment of the invention, the granular elements may be stored on a proxy before and after processing, reducing computational load and improving cache effectiveness.

According to an embodiment of the invention, stage 1103 includes step 1108 of matching and/or comparing granular elements of interest to granular elements available on proxy and replace duplicate granular elements, enabling computation load and duplicate storage reduction. In some embodiments, granular elements may be matched based on digital signature. It is noted that stage 1108 is conveniently carried out if a previous version of the source internet document exist, and may be also carried out in respect to other internet documents.

According to an embodiment of the invention, stage 1103 continues with stage 1109 of dividing large objects into smaller objects, including multiple resolution support. In some embodiments, text objects, like paragraphs, are divided into shorter spans. In some embodiments, large image objects are segmented into several smaller images. In some embodiments, large empty spaces and placeholders may be subdivided into smaller placeholders. In some embodiments, the subdivision step 1109 is performed iteratively, until reaching stopping criteria. For example, paragraphs may be divided into sentences, which are divided into words. It is noted that the smaller objects may become granular elements separately and also combined with each other or with other objects.

According to an embodiment of the invention, method 1199 includes stage 1110 of adding identification attribute per object or group of objects, using some kind of identification code or tag. In some embodiments, multiple identification tags may be used. In some embodiments, error recovery code may be inserted into the attribute structure, so that if an object looses its attribute due to error or dynamical generation, the attribute may be reconstructed from attributes of other objects.

According to an embodiment of the invention, method 1199 includes stage 1111 of adding content metadata. In some embodiments, the name of the comment authors, comment text, tags, comment author sites and other suitable metadata may be added to the content. In some embodiments the metadata present in the content may be used in order to navigate and promote the content in search engines, social networks, directories and other data processing facilities. In some embodiments the metadata is added to uncompressed public content available at e.g. 1310. An exemplary processing of metadata according to an embodiment of the invention is discussed in relation to FIG. 14.

According to an embodiment of the invention, stage 1103 includes stage 1112 of compressing granular elements. In some embodiments the content or content granules may be processed for specific purposes, including by way of illustration compression and encryption. In some embodiments, the content processing may be governed by decision rules. For example only the content is not popular in terms of traffic, is compressed and stored in long-term storage.

According to an embodiment of the invention, method 1199 may further include stage 1113 of cross-referencing content. The content matching 1108 results, tagging, user actions or any other suitable metadata may create cross-referencing between documents. In some embodiments, the cross-referencing may be used for semantic services, including by way of illustration, links between documents, cluster documents by subject, provide recommendations, enforce copyrights.

According to an embodiment of the invention, the storing and/or acquiring of content (e.g. for the source internet document) may include stage 1104 of storing embedded content, using steps 1107-1113. The embedded content may include by way of illustration frames, active objects, flash, images, documents accessible by clicking on links in the main document. The embedded content may be identified and stored iteratively, until reaching some stopping criteria. For example, store the content accessible via no more than two clicks.

If the user have marked content, method 1199 may further include stage 1105 of storing marked content, including marked objects and reference objects. The marked content may be stored separately and used for special purposes. For example, the marked content may be used for construction of preview version of the document along with thumbnail image from 1010, URL, tag and comment.

According to an embodiment of the invention, if method 1199 includes merging, stage 1106 may be carried out, wherein stage 1106 includes storing update info, including modification content, location in document, date of modification, transcoding or adaptation information or any other suitable metadata. For example, if the content was merged in 911, both the original document and the update information may stored, to enable rollback of the modifications.

FIG. 12 illustrates method 1299 for merging content, according to an embodiment of the invention. According to an embodiment of the invention, method 1299 may be used for stage 911 and for stages of method 10 such as stage 14. Content update and merge enable the version management and document replicas.

Method 1299 conveniently starts with retrieving content (from a database or over an internet connection), e.g. similar to stage 905. It is noted that the content of method 1299 may be, for example, the source internet document, portions of which, granular elements of which, and/or portions of other documents.

According to an embodiment of the invention, the retrieving may be followed by stage 1201 of filtering nuisance filter, includes analysis and classification of content changes. The content may be changed in ways not related to the visual mark, which may result in unnecessary update alerts. For example, content containing current date and time field might be modified constantly, without modification of other content in the document. The nuisance filter may contain algorithms specially constructed to deal with the nuisance information, so that only meaningful modifications may be processed by the content merge algorithm. Examples of such algorithms, include detection of frequently modified content in some spatial distance from predefined keywords, including by illustration date, time, temperature, monetary signs.

According to an embodiment of the invention, method 1299 may include stage 1202 of verifying limitations for content merge, including user settings, user marking over modified areas, and other suitable limitations. The content merge might be performed on some replicas of the document, while it might be skipped on others. In stage 1202 the merge limitations may be verified and, if necessary, an unchanged replica of the document may be created and associated with appropriate users.

Method 1299 continues with stage 1203 of making changes to an internet document, conveniently including one or more of stages 1205-1210.

Stage 1205 includes Check updates on proxy. It may be the case that the requested merge was performed or is being performed by additional users and merge results may be shared between users, reducing computational complexity.

Stage 1206 includes Find differences, including detection of deleted objects, new objects and modified objects and version tracking.

Stage 1207 includes Fix differences, including a combination of automatic and user-assisted merge methods. In some embodiments, visual marking correspond to the objects modifications in the document, which may require the user to verify the validity of visual marking.

Stage 1208 includes Modify object identifications, including modification of unique attributes for the objects that may have been added, deleted or modified, or any other suitable objects affected by modifications.

Stage 1209 includes Modify visual marking, including reference object attributes, spatial location, offsets and other suitable properties. The modifications in the document structure may require modifications in visual marking, reflecting changes in content semantics, reference objects and their attributes and other suitable modifications. For example, if user chooses to put the comments in placeholders on the white spaces and the white space disappears, a dedicated white space placeholder may be allocated. For example, when merging of visual marks during collaborative work, comments of some users may affect comments of some other users, and the merge may be performed incrementally on granular parts of the content by multiple users.

Stage 1210 includes Enable rollback, including storage of the modifications and enabling users to undo or redo any suitable modifications manually. In some embodiments, the rollback may be performed automatically if modification fails and a different merge method may be applied. For example, if automatic merge fails, user may be asked to perform manual merge. In some embodiments, the modifications may be stored in cache or long-term storage 1106 enabling future rollbacks.

Method continues with stage 1204 of performing adaptations, which may include transcoding and adaptation to user specifications. In some embodiments, the adaptations may be made incrementally for the modified content. In some embodiments, several adaptation policies may be implemented. For example, the adaptations may revalidated at content update, and when incremental adaptation fails, the adaptation may be performed iteratively on larger granular content or full content.

FIG. 13 illustrates method 1399 for modifying marked content, according to an embodiment of the invention, wherein the modifying may include transcoding, adaptation and/or customization. Method 1399 may be used with content, to marks and to metadata or any other suitable content. It is noted that the content of method 1399 may be, for example, the source internet document, portions of which, granular elements of which, and/or portions of other documents.

Method 1399 may include one or more of the following stages: content analysis 1301, customizations 1302, revalidation 1303 and updates to and from the metadata 1304. The stages may be performed iteratively until the data is sufficiently customized, valid and corresponds to metadata specifications.

Stage 1301: Analyze content, including content processing specifications, content granularity, available preprocessed results and other suitable metadata.

Stage 1302: Customize, including customization per target device, language, user settings and other specification as illustrated in stages 1305-1308.

Stage 1302 stage 1305: Specific customization based on user profile, visual marking interface and skin and other suitable specifications, including by way of illustrations toolbars, widgets, feeds, value added services selected by user.

Stage 1302 stage 1306: Translate national language, including adaptation to user linguistic capabilities, translation of measures and monetary signs and other suitable national or location-based features. The translation may apply to content, mark, talkbacks or any suitable data that may appear in various languages.

Stage 1302 stage 1307: Adapt target media, including target devices other than PC web browser (including by way of illustration mobile devices, IPTV etc), text-to-speech (including by way of illustration integrated voice response services), printed media, video or other suitable media.

Stage 1302 stage 1308: Adapt target representation, including adaptation for computer languages, presentation format, data formats, encryption, or any other suitable data representation format.

Stage 1303: Revalidate content and visual mark, including correction steps for modifications 1302 and other suitable corrective actions. For example, due to content updates, transcoding, customization or other activity, the mark may move relatively to the content.

Stage 1303 stage 1309: Compact reference objects. Verify that the reference objects may be spatially compact or take corrective actions, including by way of illustration introducing new layers, modifying object offsets, introducing dynamic code for object compaction.

Stage 1303 stage 1310: Add spaces for visual marks. In some embodiments, special layers may be added as spaces for comments, including spaces between objects, smart links or any other suitable mechanism for introducing placeholders.

Stage 1303 stage 1311: Display size adaptations, including by way of illustration code with resize event listeners and dynamic object property modification. In some embodiments, limiting the motion range of some objects may be required for consistent mark position, for example by changing object position to absolute.

Stage 1303 stage 1312: Treat specific objects, including dynamically inserted or resizable objects, objects that are not supported by target specifications, errors introduced by customization stage 1302 or other suitable objects.

Stage 1304: Update transcoding metadata. The updated transcoding metadata may be used for reducing the computational load in stages 1301-1303, for transcoding status review, for statistics and advertising or for any other suitable operation. The transcoding metadata command may include target content, device, user settings, previous transcoding status or any other suitable specifications and statistics. For example, the transcoding metadata may include status reports from content analysis, revalidation and customization in stages 1301-1303.

FIG. 14 illustrates method 1499 for managing marked content metadata, according to an embodiment of the invention. The metadata may be used for marking, searching, advertising, statistics, talkbacks, filtering or any other suitable activity. The metadata may apply to objects with various scopes, including sites, pages, sections, paragraphs, images or any other suitable objects. For example, semantic multi-resolution may be achieved by associating different tags to various nested content objects. In some embodiments, metadata may be embedded into the stored content in a representation visible for webcrawler robots, social sites or other web search and directories. In some embodiments the metadata may enable the content provider, the author of the marks, proactive users and the hosting authority with web advertising and reputation services.

It is noted that the content of method 1499 may be, for example, the source internet document, portions of which, granular elements of which, and/or portions of other documents.

Method 1499 conveniently includes some or all of stages 1401-1404, which may be carried out at least partly concurrently, but this is not necessarily so. Also, each of stages 1401-1404 may depend on results of one of the other stages, but not necessarily so.

Stage 1401 includes managing content-based metadata. The content may include stored content, cached content, content sections, referenced content or any other suitable content. The metadata may include by way of illustration keywords, tags, dates, titles, links, authors, statistics, reputation etc. The metadata may be inserted 1401 into stored and cached content replicas. Stage 1401 may include one or more of stage 1405-1407.

Stage 1405 includes managing content source, including by way of illustration the original URL of the document, the date the document was retrieved, the author of the original document, document tags and keywords, document name etc.

Stage 1406 includes managing publishing metadata, including information of including references to web sites and services which published the document, talkbacks and references to the original content, or any other suitable metadata.

Stage 1407 includes managing customizations, including embedded widgets and toolbars, corrective actions by the users, user preferences, or any other suitable metadata.

Stage 1402 includes managing content history metadata including by way of illustration list of modifications and updates of the document. In some embodiments, the list of modifications of the document may be stored in a dedicated database. The modifications of the document include by way of illustration transcoding, updates, modifications during content management stage (FIG. 9), or other suitable modifications. Stage 1402 may include one or more of stages 1408-1410.

Stage 1402 stage 1408 includes managing transcoding metadata, including changes performed by transcoding algorithm execution, (e.g. as described in relation to FIG. 13), target devices, source devices, user profiles ant other suitable metadata.

Stage 1409 includes managing preview metadata, including images in multiple scales of the content, selected content sections, titles, keywords, reputation and other suitable information for preview of the content.

Stage 1410 includes managing updates, including content availability, content replicas, modifications performed in the content as a result of content retrieval and content update, replicas of the original content, information supporting on FIG. 10-12, or any other suitable content updates.

Stage 1403 includes managing visual mark metadata, including multiple marks location, text, shape, reputation and other suitable properties. Stage 1403 may include one or more of stages 1411-1415.

Stage 1411 includes managing reputation, including author reputation, moderator reputation, mark content reputation, voting results, exposure of the content and user talkbacks or any other suitable information.

Stage 1412 includes managing sharing, including privacy protection information, sharing status, publishing to sharing sites, recipients of the document or other suitable metadata.

Stage 1413 includes managing versions, including branches, labels, merges, modifications, deletions, insertion or other suitable metadata.

Stage 1414 includes managing collaboration, including information required for multiple users collaborating on the same content online and offline. In some embodiments the browser-in-browser technology may be used for simultaneous web browsing and marking by multiple users. The metadata may include online users, editing permissions, editing status coordination, messaging between users or other suitable metadata.

Stage 1415 includes managing author customizations, including customizations signatures, logos, specific shapes and colors, or other suitable customizations introduced by the author to the mark, GUI, statistics or other suitable objects.

Stage 1404 includes managing cross-referencing, including cross-referencing between various marked content documents, original content documents, forwarded and published content, talkbacks and feedbacks, similar documents and reference documents, parts of document, marks, data chunks or other suitable objects. In some embodiments of the system, cross-referencing information may include identification information of the marked content. In some embodiments of the system, cross-referencing includes may include semantic interpretation of the marked content, including by way of illustration general category of content, keywords, tags, user groups or other suitable information. In some embodiments of the system, cross-referencing includes contextual information for advertising purposes.

FIG. 15 illustrates method 1599 for sharing marked content, according to an embodiment of the invention. It is noted that the content of method 1599 may be, for example, the source internet document, portions of which, granular elements of which, and/or portions of other documents.

Stage 1501: Mark content with text and visual markings, including mark shape, comment, tags, controls, links to other marks or other suitable mark editing. Marked content may be stored for personal, private or public use, shared, published or otherwise suitably used.

Stage 1502: Sharing decisions, including user deciding to keep the content for personal use, automatic filtering the content for specific use, banning the content from sharing or other suitable decision mechanism. The content may be marked, commented and readily available for further use. The user may decide to share content through message system. In some embodiments, sharing content creates version management mechanisms, including branch and label, which may limit further user modifications from affecting the shared version. In some embodiments, user or hosting authority may specifically enforce some changes and modifications to affect the shared version, including by way of illustration, collaboration sessions, dynamically generated content and other suitable scenario.

Stage 1503: Compose message. The user may share the content with one or many other users in a form of message, including e-mail, SMS, instant messaging or other suitable message format. The message may include information not included in the mark, such as recipients' names, personal message for recipient, sender's contact data or any other suitable content.

Stage 1504: Privacy decision. User or hosting authority may decide or modify the privacy status of the marked content. Private and public information may use different processing methods. For example, private information may be encrypted and stored separately from authors' contact details, protected by firewalls or otherwise secure. Private information may become published or published information may be transformed into private message, for example via some rewrite procedure 1509 or 1511. Some content may be shared by a group, enabling the publishing as public content, and protection as private content.

In some embodiments, when a mail list is above a threshold, the messaging may be treated as publishing, including moderator review, reputation effects, privacy and other suitable considerations. In some embodiments, several recipients may be chosen as moderators. If the response of moderators is positive, the message may delivered to other recipients bypassing spam filters.

Stage 1505: Send to moderators. Public messages and publishing materials may be sent as messages to moderators for review and voting prior to being published. The moderators may also request to ban the materials from being published. The moderators may also send requests for modifications. The moderators may be selected by user, hosting authority, or other suitable mechanism. The moderators may remain anonymous to the authors, or may disclose their identity.

Stage 1506: Vote and talkback. Moderators and users may vote for messages and write talkbacks. In some embodiments, the reputation of moderators may depend on the reputation of the published material, providing incentive for suitable editorial.

Stage 1507: Good content decision. Based on moderators voting and talkbacks, the marking on the content may be rewritten (for negative voting) or published (for positive voting). The moderator may also condition vote, on some modifications. The voting and talkbacks may be analyzed by automatic software on hosting authority, by chosen moderators, by the author or by any other suitable editing entity.

Stage 1508: For publishing bad content the authors pay penalty in financial form, in terms of reputation, or in any other suitable form.

Stage 1509: Corrections severity analysis. The correction severity analysis may be performed by author, or other suitable editing entity. If the corrections are simple, the author may choose to make rewrites and modifications and send the message for additional moderation. If the corrections are complex, the author may choose to rewrite the message from scratch or abandon current comment.

Stage 1510: The authors may rewrite the content and resend it to moderators. The content may be resent with or without the original comments to original moderators, or to other moderator.

Stage 1511: Publish content that passed moderation review. Published content may available for public use at hosting authority, search engines, social sites or any other public media.

Stage 1512: Find added value. When reader finds added value to the original comment, s/he may add a new comment to the original comment and use the modified comment independently of original material. In this case some royalties from the new comment may bee shared with the original message in terms of credit, reputation, monetary benefits or any other suitable payment mechanism.

Stage 1513: Secure content decision. The decision may be made based on user profile, user directive, keywords or other suitable mechanism. Secure content may be encrypted, stored on a separate server or otherwise protected.

Stage 1513: Encryption of secure content, includes encryption, password protection, firewall, invisibility to web crawlers or other suitable methods.

Stage 1514: Send message to the recipient device. The recipient may be single entity, group of recipients or a combination of thereof.

For example, method 1599 may include documentation for purchase of particular device in an organization. The initiator of the purchase, may mark specifications and cost of several alternative products, explaining in marked comments pros and cons of each option. The message may be stored for working team use, until the list of alternatives is finalized. The message may be sent and moderated by project management and department management, which may ask for modifications of the message. The modified message may be published for review by decision makers. The decision makers may choose one of the alternatives and ask for in-depth study of the alternative, resulting in additional marking creation.

FIG. 16 illustrates method 1699 for monitoring messages, according to an embodiment of the invention.

Stage 1601: Monitor author reputation, including composed messages, sent messages, private comments and other suitable parameters. In some embodiments, author reputation may be used to sort and promote messages.

Stage 1602: Monitor information efficiency of the message, including the efficiency of the mark and comment, and may include several stages.

Stage 1602 stage 1607: Monitor message reputation, including user voting, moderator comments, or other suitable criteria. Reputation of the published content or message may influence content efficiency, via hosting authority actions, reader's interest and trust or other suitable mechanism. Reputation computation is illustrated in relation to FIG. 17 and FIG. 18.

Stage 1602 stage 1608: Monitor message focus. Semantic focus and semantic multiresolution provided by visual marking, author comments, tag and other suitable mechanisms. Semantic focus may be measured by the ratio of selected content to total content available on the web page, by the size of selected content and comment sentence, or by other suitable criteria.

Stage 1602 stage 1609: Monitor source content, including source page rank, reputation, social bookmarking status, or other suitable information provided by content provider, search engine, web analytics or other suitable entity. Source content with high statistics may encourage more comments and page views than anonymous content.

Stage 1603: Monitor exposure efficiency, including user exposure of the message following marketing push, pull and viral marketing, or any other suitable content exposure.

Stage 1603 stage 1610: Monitor forwarding rate or other suitable viral marketing activities. Forwarding includes a viral marketing activity preformed by proactive users. Forwarding may apply to distribution of the original marked content, derivatives of the marked content with additional marking, published marked content or other suitable documents and data objects. Forwarding via services of hosting authority or other suitable services visible to hosting authority, may be monitored and awarded with reputation or other suitable incentive.

Stage 1603 stage 1611: Monitor sent messages or other suitable marketing push activities. Messaging includes marketing push techniques that can be performed with mailing lists of various sizes, via email, SMS, instant messaging or other suitable media. In case of long messaging lists, some recipients may function as moderators prior to exposure of other readers to the marked content.

Stage 1603 stage 1612: Monitor published content and other suitable marketing pull activities. Publishing includes marketing pull techniques, which generate user attention via social sites, search engines and other public media. The number of visitors to the marked page, the method via which they arrived at the content and other suitable statistics may enable monitoring of publishing efficiency.

Stage 1604: Monitor reader response, including reader attention and reader actions monitoring.

Stage 1604 stage 1613: Monitor reader reaction that results in voting, talkback, forwarding other suitable reader acts. These acts may be measurable directly by the hosting authority.

Stage 1604 stage 1614: Monitor reader attention, including measuring the number of visitors that read the marked content pages, how much time the readers spend reading some sections, how much mouse clicks various sections of the content and cross-references generate, or any other suitable statistics.

Stage 1604 stage 1615: Monitor specific actions, including specific statistics generation. For example, monitor characteristics of people that click on cross-referencing in their message to see further works on the particular subject or by the specific author. For example, monitor user request to ban specific materials and take corrective steps if the number of requests exceeds some level.

Stage 1605: Monitor message efficiency, including composite indices generated via formula, decision rules, or other suitable mechanism from statistics measured in 1602-1604.

Stage 1606: Monitor monetization efficiency, including advertisement efficiency, premium content usage, viral marketing utilization or other suitable criteria. Advertisement pricing may be set efficiently according to message efficiency, form of user reaction, user activity in viral marketing or other suitable criteria.

FIG. 17 illustrates method 1799 for marked content reputation computation based on measurable parameters, according to an embodiment of the invention.

Stage 1701: Manage marked content reputation, including by way of illustration, computation of suitable parameters and combination of various parameters into reputation score, managing marked content status (new, recommended, banned or other suitable status) based on reputation score, integrating authors, moderators, readers and automatic tools for marked content evaluation. In some embodiments, the content score may be calculated for particular reader as content matching score of the marked content to user profile.

Stage 1701 stage 1703: Manage source reputation, including the author, moderator, original content reputation or any other suitable attribute of the marked content.

Stage 1701 stage 1703 step 1706: Manage author reputation, including author reputation management as illustrated in relation to FIG. 18, feedbacks between message reputation and author reputation, disciplinary actions, promotion actions, and other suitable practices. For example, if an author wrote several messages with common traits (high or low reputation, adult content, specific subject or other suitable traits), it may be reasonable to project the common traits between the author and the messages. The author may be an individual or a collective of authors, in which case the reputation may be calculated as a weighted norm of reputations of all authors.

Stage 1701 stage 1703 step 1707: Manage moderators reputation, including previous voting, personal preferences, reaction of other moderators or other suitable information. For example, if moderator's reaction is very heterogeneous, the marked content may deal with controversial subjects. For example, if moderator's response predicted well previous readers' response, the moderator's reputation and influence on the marked content may be higher.

Stage 1701 stage 1703 step 1708: Manage original content reputation, including page rank, fraud and security status, or other suitable parameters.

Stage 1701 stage 1703 step 1709: Manage cross-referencing, including reputation of referenced comments and content, number of references, form of referencing or other suitable parameters.

Stage 1701 stage 1704: Manage reader reaction, including reader talkbacks, voting, personal reader reputation, group reputation or any other suitable statistics.

Stage 1701 stage 1704 step 1710: Manage voting reputation, including average voting result, voting rates, voting heterogeneity or other suitable statistics related to reader voting.

Stage 1701 stage 1704 step 1711: Manage talkbacks reputation, including number of talkbacks, reputation of talkback authors, keywords inside talkback comments or other suitable statistics.

Stage 1701 stage 1704 step 1712: Manage reader reputation, including reader activity, previous disciplinary actions, reader's marked comments, reader conformance with groups or other suitable information.

Stage 1701 stage 1704 step 1713: Manage viral reputation, including forwarding rates, reputation in discussion groups, social networking status or other suitable information.

Stage 1701 stage 1705: Manage hosting-related reputation, including page rank, disciplinary actions, promotional actions or any other suitable mechanism.

Stage 1701 stage 1705 step 1714: Manage readers attention, including number of talkbacks, page-views, voting, time per page, focus on the page, clicks on referenced links, clicks on advertising or other suitable parameters.

Stage 1701 stage 1705 step 1715: Manage disciplinary actions, including ban or limitation on the message, user requests for message ban, detection of presence of specific keywords, adult content detection, privacy violation detection or other suitable disciplinary activities.

Stage 1701 stage 1705 step 1716: Manage promotional actions, including posting as a new message, recommended message or sponsored link, cross-referencing from high-reputation links, positioning in search and directories, posting in discussion groups or other suitable promotional activity.

Stage 1702: Manage contextual metadata, including semantic metadata, advertising metadata or other suitable metadata. The semantic metadata may include tag, comment, content keywords. In some embodiments, the contextual metadata can be enriched by the reputation system. For example, if particular author is interested in several subjects, and most readers have subjects in common, the common subjects may be added to directory listing or keywords metadata. For example, the content that generates many talkbacks and cross-references may be more likely for reader to be proactive and click on sponsored links. For example, if users concentrate their attention on particular marked sections in a document, the section may enable more accurate semantic analysis and more effective advertising, including smart link or other suitable monetization techniques.

FIG. 18 illustrates method 1899 for user reputation computation, based on measurable parameters, according to an embodiment of the invention.

Stage 1801: Manage user reputation, including account reputation, user marking, user activity, disciplinary actions or other suitable parameters.

Stage 1801 stage 1803: Manage account reputation, including type of account, amount of trust generated by other users, social activity, identity verification or other suitable information.

Stage 1801 stage 1803 step 1806: Manage premium services, including personality verification, billing history, premium account bonuses, promotional activities or other similar mechanisms.

Stage 1801 stage 1803 step 1807: Manage social activities, including reputation network, presence on social sites, mailing list characteristics, presence in discussion groups or other suitable activities.

Stage 1801 stage 1803 step 1808: Manage disciplinary actions, including banned content, fraud accusations, abusive language, untruthful comments or other similar activities.

Stage 1801 stage 1804: Manage marking reputation, including reputation of written and moderated comments, or other suitable information.

Stage 1801 stage 1804 step 1809: Manage author activities, including private and published marks, comments and messages, reputation of published comments, or other suitable activities.

Stage 1801 stage 1804 step 1810: Manage moderator activities, including responsiveness for moderating, amount of editing suggestions, conformity with readers' views or other suitable activities.

Stage 1801 stage 1805: Manage user activity reputation, including voting, talkbacks, content views or other suitable information.

Stage 1801 stage 1805 step 1811: Manage voting activity, including proactive users detection and endorsement, areas of interest, voting conformity, range of voting marks or other suitable voting attributes.

Stage 1801 stage 1805 step 1812: Manage talkback activity, including presence of specific keywords, amount and quality of response by other users, amount and quality of response to other users, perceived amount of expertise or other suitable parameters. For example, if a talkback is between 50 and 250 words, and another talkback relates to the original talkback using keyword “great”, the original talkback may be attributed with personal expertise.

Stage 1801 stage 1805 step 1813: Manage forwarding activity, including personal messaging, comments on marked content, posting into social sites and discussion groups, or other suitable activities.

Stage 1802: Manage behavioral metadata, including user interests, user activity levels, groups of users with similar tastes or other suitable metadata. Behavioral metadata may be useful for applications, including by way of illustration behavioral advertising. In some embodiments, the behavioral metadata may be shared with other services, including advertising networks. For example, the semantic clouds of subjects with high user activity may indicate fields of interest and personal preferences.

FIG. 19 illustrates a second internet document 1999, according to an embodiment of the invention. It is noted that, according to an embodiment of the invention, granular elements and marking illustrated may be independently stored and/or managed.

For example, the visual bookmark may be activated via a bookmarklet stored in “MyFavorites” of the browser.

Objects 1901-1903 illustrate some content on the original site (e.g. portions of the source internet document).

Object 1901 illustrates a paragraph with some text, images and other objects.

Object 1902 illustrates a frame. Inside the frame there may be a paragraph with some more text and images.

Object 1903 illustrates a large image

Objects 1904-1906 illustrate a toolbar that may be added, according to an embodiment of the invention, to a marked content, and may be a part of an aforementioned user interface (e.g. in relation to stage 40).

Object 1904 illustrates a sidebar, according to an embodiment of the invention, containing buttons for editing, navigation and monitoring. When editing a new mark, the sidebar may provide editing functionality. Sidebar 1904 may be a part of an aforementioned user interface (e.g. in relation to stage 40).

Object 1905 illustrates status bar, according to an embodiment of the invention, with URL of the original site, tag given by the user, and other suitable statistics. Status bar may be a part of an aforementioned user interface (e.g. in relation to stage 40).

Object 1906 illustrates user interaction control, which enables user voting and contains talkbacks, cross-references, reputation etc. user interaction control interface 1906 may be a part of an aforementioned user interface (e.g. in relation to stage 40).

Objects 1907-1912 illustrate two markers.

Object 1907 point 1 may be implemented by a circular shape distributed over objects 1901 and 1902. By way of illustration, the mark may imply the following processing:

Mark operation 1: Unite objects 1901 and 1902 in one layer, so that they are not moved by screen resize and transcoding.

Mark operation 2: Since only parts of 1901 and 1902 fall under the mark, the spans representing each line in both objects may be allocated a dedicated layer limited to take one text line.

Mark operation 3: A partially transparent spiral shape may be placed over the marked area with given offset in each line layer.

Objects 1908 comment 1 may be implemented by a comment with several words, which may be, by way of illustration, automatically placed in the space between objects 1901 and 1902, left to the mark 1907 with a fixed offset between the mark 1907 and the end of the comment 1908.

Objects 1909 talkbacks 1 may include talkbacks and discussion relevant to comment 1 and point 1 only.

Object 1910 point 2 may include a partially transparent circular object that appears over the image 1903 with given offset inside the image.

Object 1911 comment 2 may include a text appearing over the background of the image in close vicinity to point 2. During transcoding the location for the comment may be selected by the author, by segmentation algorithm or other suitable mechanism.

Objects 1912 talkbacks 2 may include talkbacks and discussion relevant to comment 2 and point 2.

FIG. 20 illustrates method 2099 for pattern-based marking, according to an embodiment of the invention.

Stage 2001: Perform pattern matching. Pattern matching may include keyword matching, full or partial image matching, object identification, semantic role modeling or any other suitable algorithm. Pattern matching may be performed by hosting authority, search engine, security filtering software, visual search application or any other suitable application. A possible outcome of pattern matching may be a detection map of patterns as they may appear in the document, parts of document, objects and data chunks.

Stage 2002: Highlight detected pattern. The detected pattern may undergo hard or soft thresholding, double thresholding, classification or any other suitable decision process. The output of the decision process may be associated with some attribute or set of attributes. The attribute may appear as highlight, for example by different color highlight for each keyword or semantic role.

Stage 2003: Detect selected objects. The output of the pattern detection may be associated with the relevant structures of the underlying content. For example, keyword detection may be associated with a paragraph in text. The following detection of selected objects may be used:

Stage 2003 step 2006: Analyze pattern density. Density of detected pattern or highlighted attributes may be compared for various objects in the document, yielding pattern density per object. The analysis of pattern density per object, including by way of illustration, clustering, thresholding and decision based on neural network.

Stage 2003 step 2007: Select candidate objects. From the analysis of pattern density, the candidate objects may be selected. For example, the objects that contain more than a given number of keywords, or significantly more keywords than other objects may be selected as candidates.

Stage 2003 step 2008: Analyze selection features. For selected candidates objects and for some other suitable objects, additional features may be calculated. For example, if only part of a paragraph contains keywords, the keyword distribution in the paragraph may be uneven.

Stage 2003 step 2009: Verify candidates. The results of analysis of the selection candidates may be used for candidate verification methods. For example, if two consecutive paragraphs contain keywords, they may be merged into one layer. For example, if only part of a paragraph contains keyword, the paragraph may be split into two spins. For example, if one paragraph contains all keywords, and another paragraph contains only one keyword, only the paragraph with all keywords may be valid. For example, if the system is configured to produce only one candidate per document, the best candidate may be selected.

The output of verification process may include a list of selected objects.

Stage 2004: Associate mark with detection. For each selected object, a relevant mark may be generated. The mark may include selection statistics and document metadata, including by way of illustration, the title of document, the title of selection, the pattern matching query, measure of how well the selected object corresponds to pattern matching criteria, or any other suitable attribute.

Stage 2005: Perform post-processing. In some embodiments, post-processing may be executed, including ordering several documents based on selection features, notifying user, creating report or any other suitable method.

FIG. 21 illustrates method 2199 for sharing content (e.g. “send to a friend” application), according to an embodiment of the invention.

Stage 2101: Activate send to a friend. “Send to a friend” may be activated via a script or button in blog, forum, web browser, messaging application, mobile device or any other suitable mechanism. For example, a blog may include “send to a friend” button, which may activate the illustrated embodiment.

Stage 2102: Perform marking process. The marking process includes the following steps:

Stage 2102 step 2107: Activate browser-in-browser. The browser-in-browser mode may be activated for the active URL. For example, the document may be opened in a new window with marking interface embedded into the window.

Stage 2102 step 2108: Verify and save content. The content may verified by the user vs. the original document. If any corrective actions are required, the corrective actions may be recorded and reused for recipient's benefit. The verified content may be stored on local device or remote proxy for further use.

Stage 2102 step 2109: Mark selected areas. User may select and mark objects of interest, parts of objects, data chunks or combination of thereof.

Stage 2102 step 2110: Add tag and comment. User and hosting authority may add tags, comment and other suitable metadata to the stored content, marked selection or other suitable data container.

Stage 2102 step 2111: Add animation. The marked selection may be associated with events, effects, portfolio and viewing sequences. The stored documents and marked selections may be linked to other stored documents and marked selections.

Stage 2102 step 2112: Modify properties. The user or hosting authority may modify properties of the stored documents and marked selections, including privacy and security settings, notification upon delivery, digital signature, reputation and other suitable properties.

Stage 2103: Import address book. In some embodiments, the address book may be imported from local device, social site or other suitable data source. The address book may be stored on the hosting authority. The address book import may include full data import, incremental import of modified addresses, data recombination from multiple sources or other suitable mechanism. The addresses may include URL, email address, phone number, IP address, username or any other suitable identifier for message delivery.

Stage 2104: Select recipients. In some embodiments, user or application may select on or multiple recipients, groups of recipients and combination of thereof.

Stages 2103 and 2104 may be redundant when publishing data for public use.

Stage 2105: Transcode and adapt. In some embodiments, the selected document and marked selection may be transcoded and adapted according to application requirements, target device, user selection, hosting authority policies or any other suitable rule set.

Stage 2106: Send and publish. In some embodiments, the selected document and marked selection may be sent to the recipients or published on web-site or other media.

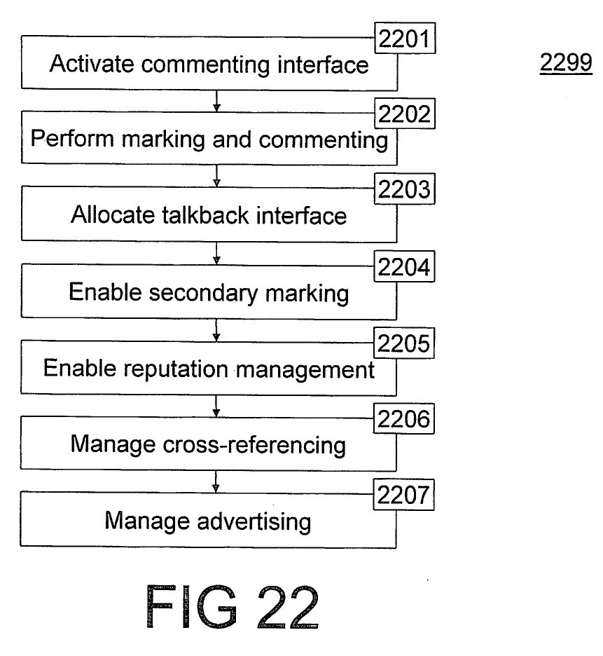

FIG. 22 illustrates method 2299 for managing talkbacks, according to an embodiment of the invention.

Stage 2201: Activate commenting interface, including by way of illustration pressing “add comment” or “view comments” button on user interface of a web site or web browser, pressing a link on existing comments in a web site, hovering with mouse over annotations on margins of web text, or any other suitable user action or event. The commenting interface may include a new window with marking and commenting GUI, toolbars and marking that may be activated in existing window, or any other suitable control and monitoring mechanism.

Stage 2202: Perform marking and commenting, including highlighting, marking with a circle, adding arrows, underlining, adding text comments, tagging, voting, or any other suitable marking and commenting mechanism. In some embodiments, the marked content may be stored on hosting authority that may be different from content provider. In some embodiments, the marked content and user comments may be stored in the portfolio of the user adding the comment and associated with reputation of the commenting user.

Stage 2203: Allocate talkback interface. In some embodiments a dedicated interface for further talkbacks and voting may be allocated and associated with original comment. For example, dedicated talkback interfaces enable tagging and discussions relevant to some focused section of the content. For example, semantic multi-resolution may be enabled by limiting comments, voting, talkbacks and tagging to objects with different scope, including sites, pages, sections, pages, paragraphs or any other suitable object with suitable scope. In some embodiments, the talkback interface may be available via the user portfolio of the commenting user and cross-referenced to the original content provider site.

Stage 2204: Enable secondary marking. In some embodiments secondary marking may be enabled. For example, when user B comments on talkback of user A, user B may mark the content of user A. In some embodiments, the graphical marking attributes including visibility may change when an event including mouse focus or click on text comment is triggered. For example, when user B comments on talkback of user A and original content, the visual marks of user B may be visible only when the text comments of user B are clicked by any suitable user.

Stage 2205: Enable reputation management, including user voting, page view, areas of the page that may be marked, statistics of mouse hovering over various areas of the content or other suitable information. In some embodiments, the events inside the user portfolio, including page views and voting, may be synchronized with events in the content provider's interface. In some embodiments, dedicated reputation-related controls may be added to the GUI.

Stage 2206: Manage cross-referencing, including cross-referencing with the content provider, cross-referencing with other comments of a chosen user, cross-referencing with similar sites, or any other suitable content. In some embodiments, the cross-referencing may be created automatically based on user portfolios, tagging and keywords, metadata in the original content or any other suitable metadata. In some embodiments, users may manually trigger cross-referencing based on personal preferences.

Stage 2207: Manage advertising, including advertising in user portfolio and advertising on the content provider site. In some embodiments, behavioral advertising may be selected based on portfolio of the specific user. In some embodiments, contextual advertising may be selected based on semantic scope of the marked section.

With respect to the above description, it is to be realized that the optimum dimensional relationships for the parts of the invention, to include variations in size, form, function and manner of operation, integration and use, are deemed readily apparent and obvious to one skilled in the art, and all equivalent relationships to those illustrated in the drawings and described in the specification are intended to be encompassed by the present invention.

Therefore, the foregoing is illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

It is noted that, according to different embodiments of the invention, two or more of the methods discussed in relations to FIGS. 4A, 4B, 4C, and 7-22 (or portions of such methods) may be combined, either as taught above or in other useful combinations.

According to an embodiment of the invention, the methods, systems, and computer program products herein disclosed (among which is, according to an embodiment of the invention, method 10) combine the two or more of following operations: (1) smart web content storage and analysis, (2) graphical marking and (3) efficient sharing and reputation management.

Operation 1: Smart web content storage and analysis enables efficient storage and consistent access to information on web pages which may be password-protected, dynamically generated or modified over time.

Operation 1 feature 1: User redirection. In some embodiments, the user may redirected via bookmarklet, link, Java code or any other suitable software mechanism, from URL content available by default to the content associated with aforementioned URL by a remote proxy. In some embodiments, the remote proxy may produce constant content when the content of the original site is modified. By way of illustration the URL-associated content may be stored on distributed database, local hard disk, peer-to-peer network, dedicated file system or any other memory device. In some embodiments, the user may choose to update the stored content depository with some of the modifications in the original site associated with URL. In some embodiments, multiple versions of content may be stored by the system, reflecting various events and user actions, including by way of illustration, content update, translation; content adaptation, user login etc.

Operation 1 feature 2: Recording user operations. The web page of choice may be protected or dynamically generated, and user's actions may be required to activate the web page in a suitable form. In some embodiments, the user actions may be recorded by the system for further use via automatic scripts, validation rules or any other information reuse mechanism. In some embodiments, the user actions are recorded via proxy-based browser with browser-in-browser technology, as described in patent application 60/973,910. In some embodiments, the user actions may be encoded and hidden from the hosting authority to protect the privacy of the user.

Operation 1 feature 3: Granularity. In some embodiments, the web content of interest and the content embedded in it may be divided into objects or chunks of data of suitable size for pattern matching, storage, transcoding or other suitable data processing algorithm. For example, images embedded in a web page may be represented by granular objects, separate from the granular object of the text of the web page. In some embodiments, data processing algorithms may be performed in parallel fashion on independent chunks of data.

Operation 1 feature 4: Removing duplicate content. In some embodiments, pointers to objects or data chunks may be used instead of copies of the objects and data chunks. In some embodiments, pointers vs. data storage policies enable storage space vs. download speed optimization. In some embodiments, if the web page of interest or a part of it already exists on the remote proxy, a pointer to the existing copy may be stored instead of full content.

Operation 1 feature 5: Compression. In some embodiments, the objects and data chunks may be preprocessed prior to storage. The preprocessing operations include encryption, compression, digital finger-print extraction and execution of other suitable algorithms. In some embodiments, the preprocessing operations may be associated with governance policies. For example, if the web page of interest or a part of it is not viewed over a long period of time, it may compressed to save storage space.

Operation 1 feature 6: Tracking modifications. In some embodiments, certain events may cause user involvement. In some embodiments, if the content corresponding to URL selected by user is modified, the user is informed. The user may choose to modify the web page or to keep the old web page copy. In some embodiments, the user may add events related to values of objects on some web page. For example, the user may add an event on weather site to send email notification if it rains the next day. In some embodiments, the user may track comments introduced to web content by other user. For example, the user may choose to get an SMS notification if the content of choice was seen and commented by chosen friends.

Operation 1 feature 7: Tiny URL. In some embodiments, the stored web page may be assigned with special URL. In some embodiments short URL may used. In some embodiments the URL may be associated with users, comments, tags or other suitable contextual information.

Operation 1 feature 8: The user, the hosting authority or other suitable entity may modify data in the stored copy of the content. In some embodiments, the entity may add metadata to the stored content. In some embodiments, the entity may add link to site, increasing site's exposure in search engines, social networks or other suitable web authority. In some embodiments, the entity may add logo, links, comments, tags, and other content to stored data. In some embodiments, the entity may remove scripts, advertising or other suitable objects.

In some embodiments, the user, the hosting authority or other suitable entity may utilize stored content for promotion in search engines, social sites and other advertising networks of user's reputation, the original content and related site, the brands and topics being commented and other similar content.

Operation 2: Graphical marking enables user comments and emphasis on the original web content in effective and consistent fashion.

Operation 2 feature 1: Graphical symbol for user selection. In some embodiments, the user may draw a mark with shape, such as a circle or rectangle or any other suitable shape, in order to mark selection area. The selection mark may be associated with the objects inside the selected visual range, such as paragraphs, images, video or other suitable objects. A selection mark may cover any object or data chunk, including by way of illustration single DOM object, multiple DOM objects, part of DOM object or a suitable combination of thereof. The association of selection with visual range enables selection of text paragraphs, background areas, image sections, Flash controls or other visible objects of the web content, including objects unavailable for other methods of selection.

In some embodiments, the selected objects or data chunks are graphically marked for user display by a specially designed shape, including by way of illustration partially transparent shape, shapes with random edges, shapes mimicking handwriting, shapes with logos or any other suitable custom designed shape. Unlike commonly used highlighting, the shape marking may not change object background, can work with text, images and flash/video.

In some embodiments, the selection mark may be associated with graphical placeholder on the stored content, including by way of illustration place for shape edges, place for logo, place for comments, place for content statically or dynamically generated from RSS feed, script or other suitable data source.

In some embodiments, the selection mark may be associated with background or uniform areas, placeholders or automatically selected areas within the context of the whole document, a frame in the document or other large object. In some embodiments, several selection marks may be cascaded or mixed for objects or data chunks in the web content.

In some embodiments the shapes may be specifically design to be visually different from the original content, including by way of illustration introduction of handwriting imitation method. For example, instead of perfect closed circles and rectangles imperfect spiral-like shapes may be use. For example, small hand tremble may be imitated via random noise generator.

Operation 2 feature 2: Automated marking. In some embodiments, the selection area may be marked automatically based on suitable features and statistics. In some embodiments, the automated marking may be used with search capabilities for keyword search, likeness search, graphical search, security information detection, spam filtering or any other suitable pattern matching application. In some embodiments, the mark may be applied to an object, part of object, several objects and combinations of thereof. For example, in keyword search a sentence or a paragraph with high concentration of chosen keywords may be marked with a circle.

Operation 2 feature 4: Statistics within selection area. In some embodiments, statistics of objects inside the marked selection may be provided. For example, the user may see statistics of keyword concentration in marked area with respect to second detection candidate, statistics for the whole document and user selection.

In some embodiments, processing may be performed based on the statistics within selected area, including by way of illustration, selection of additional areas, selection of a part of the area instead of the whole area, removing the selection from unsuitable areas, grading the selection vs. other selections, providing detection rates for third party tools or any other suitable processing.

In some embodiments, the selection mark may be modified according to statistics inside the mark, target device, user section, context information or other suitable statistics. For example, a selection mark may incorporate popularity rank and author reputation display.

Operation 2 feature 5: Animation of graphical marking. Graphical marking may be associated with events, animation effects, external feed or other dynamically generated data. The events may include by way of illustration, mouse actions, keyboard actions, timer, hyperlink and flash button activation, events sent by remote server. The effects may include by way of illustration fade in/fade out, color and size variations, shape motion, switching between multiple shapes, dynamically generated or scrolling text. External feed may include by way of illustration, user voting, hosting authority action, RSS feed input, streaming video from collaborating device.

In some embodiments, dynamically generated marking may be associated with static marking. For example, a video sequence may be marked with explanation of the desirable effect, and the object of interest inside the sequence may be marked with dynamic marking.

In some embodiments, selection mark may be represented by an animated object, by way of illustration Flash object. In some embodiments, the original marked content may be rendered invisible and a modified replica of marked content may be added to the selection mark object.

In some embodiments, marks may be associated with serial numbers or ID tags and ordered into a slideshow-like fashion. The user may construct and navigate within sequences from multiple marks. Each mark may participate in multiple sequences.

Operation 2 feature 6: Consistent marking for dynamically generated content. Dynamically generated content may include by illustration web pages which may be modified based on user action, timer, webmaster activity or other suitable editing action and embedded content that may be modified via third party and may not be available due to cross-site security limitations. In case of dynamically generated content, the prior art methods of finding an object in DOM structure, such as XPath and XPointer standards, may fail. In some embodiments, visual marking associated with object ID of the stored content may enable consistent marking for dynamically generated content.

Operation 2 feature 7: Comments, tags and discussion. In some embodiments, the selection marks may include user comments. For example, a user may provide personal commentary regarding the marked text.

In some embodiments, the marked content may be accompanied with tagging system. The tags may be created manually by the users, automatically from keywords and content metadata, imported from third-party system, generated by application or generated and modified by any suitable tagging mechanism.

In some embodiments, the selection marks may be supplied with interactive fields. In some embodiments, the interactive fields of selection marks may be used for talkbacks, discussion, forum, voting or any other suitable user activity.

The illustrated marking enables multiple resolution of the content in semantic plane from essence to context:

Semantic multiple resolution level 1: User content and tag may offer the shortest form of the message a user can convey.

Semantic multiple resolution level 2: Marked objects and discussion may enable in-depth exploration of user's comment.

Semantic multiple resolution level 3: The original web page on which the marking was performed and sequence of markings may enable analysis of the bigger picture and context.

Operation 2 feature 8: Collaborative development and version control. The marks may be created and stored in a form that enables user collaborations, including collaborating browsing and marking.

In some embodiments, multiple users may activate the browser-in-browser technology from and view same browsing interface from multiple devices. The browsing interface may allow simultaneous access for multiple users, recorded sessions for user collaboration, browsing session continuity from multiples devices or any other session configuration for one or many users utilizing one or many devices.

In some embodiments, multiple users may mark documents as collaborating team. The collaborating users may work as co-authors, as authors and editors, as commentators or in any other suitable team configuration. In some embodiments, multiple users may mark content independently and then merge marks using some suitable version tracking software. In some embodiments, version tracking software may be used for managing multiple marking sessions by multiple users.

In some embodiments, users can mark content already marked by another users and share the marked content independently from the original marking or in collaboration with original marking. In some embodiments, the marking operation may be repeated by multiple users over multiple generations of marking.

Operation 3: Efficient sharing of the web content and reputation management of users may increase the chances that the reader will address the content and decrease the effort required to access the suitable content. In some embodiments, specific features may be developed for use with marked content or browser-in-browser technology.

Operation 3 feature 1: Message generation. A message may be generated manually or automatically, including by way of illustration the following details:

Message detail 1: Sender contact details. Sender contact details may include sender reputation, sender details on third party services, sender details on hosting authority and other details related to the sender. Sender's contact details may be available via user registration, integration with third party services and other identification methods.

In some embodiments, sender's content details may be verified via identity verification services.

Message detail 2: Recipient contact details. Recipient contact details may include recipient address on third party services, recipient username on hosting authority, recipient's device, recipient's national language and other details related to recipient. Recipient's contact details may be available via sender's address book, talkback lists, integration with third party services and other techniques.

In some embodiments, recipient's content details may be imported from social network or personal address book.

Message detail 3: Subject and content. Message subject may be available from user tag and comment, original site URL, title and metadata, keywords, or other suitable mechanism for content identification. In some embodiments, the message may contain redirection URL or tiny URL of marked web content stored on remote server. In some embodiments, the message may contain icons or preview thumbnails of the content.

In some embodiments, some message details may be encoded or protected, enabling security and privacy protection of the users.

Operation 3 feature 2: Multiple delivery options. The illustrated invention may utilize multiple delivery services, devices and media, including by way of illustration Email, SMS, Blog, Widget, Flash or Video, Bookmarking site, instant messaging, CRM applications or any other suitable communication method.

In some embodiments, screenshots and various preview options may provide visual impression of the media as seen by the sender on sender's device.

The messages and stored content may be sent from any device and to any device using transcoding algorithms according to specifications of various devices, including by way of illustration IPTV, mobile device, printed media etc. Integrated messaging and proxy-based storage and processing enable multiple transcoding and customization features, such as:
a. Transcoding to target device and browser capabilities.
b. Translation of national languages.
c. Transcoding of computer languages.
d. Blocking advertisement.
e. Adding software as service capabilities.
f Changing visual appearance of the content according to user-specified schemes, i.e. “skins”.

Operation 3 feature 3: Built-in response capabilities. In some embodiments, each marked page may include platform for talkback forum and redirection management.

The recipients of the message may vote for the message or against the message. In some embodiments, the voting of the recipients may modify the reputation of the message and sender. High-reputation messages and messages from senders with high reputations may be more likely to be read by the recipients.

Operation 3 feature 4: Send to a friend. The illustrated invention may be activated via “send to a friend” button on blogs, forums and messaging systems.

By sending a message to a friend, a user may increase his own reputation and provide valuable information for the friend. The reputation score may serve incentive to use the proposed messaging system.

Operation 3 feature 5: Creating personal portfolio. Storing and marking web information enable user create personal portfolio, that in turn increases user reputation and search engine presence. In some embodiments, the personal portfolio may be ordered according to users, subjects, dates and other criteria. Each marked content may appear in none, one or multiple portfolio, using for example some pointing system. In some embodiments, the personal portfolio may be actively promoted in search engine, advertising networks, social sites and other suitable media.

Users my publish marked web pages on hosting authority, group sites, public sites, private sites or any other media.

Operation 3 feature 6: Reputation management. The reputation of a user may be calculated based on reputation of all messages sent by the user, all messages forwarded by the user, user activity in saving information for private use, user activity on hosting authority, user's social profile or any other suitable user information.

In some embodiments, users may vote for messages. User vote may change reputation of a message and reputation of a sender. Users may get additional reputation points based on their activity on the site, such as a number of sent messages, amount of stored content, amount of published content and page views.

In some embodiments, reputation progresses along delivery-based pyramid. For example if a message is sent by user A and forwarded by user B to user C, the vote of user C will be fully reflected by user B and partially reflected by user A. The reputation distribution feature may creates an incentive to forward a message to a friend.

The users' attention may be monetized. In some embodiments, reputation points maybe bought and sold for money based on some dynamically set exchange course.

In some embodiments, antispam mechanisms may be associated with user reputation. For example, users willing to forward multiple mails may be required to make a financial deposit proportional to expected exposure. Users willing to publish content may be required to present content with high reputation from moderators. Users that create content by collaborative marking may share the reputation with moderators. An offended user can recommend to the hosting authority banning a message from public use.

System for efficient web messaging. By combining operations 1, 2 and 3 and adding dedicated application framework an efficient web messaging system may be created.

System feature 1: Any web page, a part of web page or data chunk may be used for web messaging. Outdated, deleted, password-protected and dynamically generated web pages may be substituted by stored copies of the data. Integrated messaging via multiple media enables recipients of various media [email, SMS, blogs, social networks, video on PC, mobile devices, IPTV] get similar messages to various devices.

System feature 2: Reputation filtering. Reputation filtering based model may provide incentive for the sender to send only valid messages and incentive for the recipient to be proactive, including voting for messages and message sources, message forwarding etc. Unique reputation filtering model details are described in detailed description.

System feature 3: Message effectiveness may be measurable, calculated and controlled via algorithms based on reputation, exposure, user voting or any other suitable statistics. Effective users of the system may get reputation points and may be promoted in search engines and social networks.

System feature 4: Users may create content via collaborative storage, marking and messaging process, using application structures mimicking partnership and company legal structures.

System feature 5: Semantic multiresolution. Users may create short messages, pointing to specific section of web pages, and linking multiple web-pages into subject-related portfolio. A message maybe represented via multiple connected levels of semantic content, enabling users to choose the desired level of semantic analysis of the content.

System feature 6: Automatic marking. Automatic marking and statistics may be created based on content features, such as keyword density, semantic role modeling, visual features, common patterns and other suitable features.

According to an embodiment of the invention, a computer readable medium is disclosed, the computer readable medium having a computer readable code incorporated therein for managing content, the computer readable code including instructions (which are executable by one or more computers) for: (a) acquiring a source internet document over an internet connection; (b) dividing the source internet document into multiple granular elements, to provide a group of interrelated granular elements (wherein it is noted that according to an embodiment of the invention, a spatial relationship may be defined for any granular element in respect to at least one other granular element); (c) adding metadata to the granular elements (d) receiving granular element associated information from a web user, wherein the granular element associated information is associated with a referenced granular element that is selected in response to user selection; (e) generating, in response to metadata of at least one granular element, a second internet document that includes the referenced granular element, other granular elements, and the granular element associated information; and (f) providing the second internet document over an internet connection.

According to an embodiment of the invention, the instructions for the providing of the second internet document includes instructions for providing the second internet document to another web user.

According to an embodiment of the invention, the computer readable code further includes instructions for providing a user interface for marking a portion of the source internet document, wherein the referenced granular element is at least partly referenced by a marking of the user.

According to an embodiment of the invention, further includes instructions for generating, following the dividing, at least one granular element in response to the marking of the user.

According to an embodiment of the invention, the instructions further includes recording a marking of the user using spatial parameter responsive to a graphic display of a browser-within-browser module.

According to an embodiment of the invention, the instructions for the providing of the second internet document are responsive to a received query for the source internet document, and includes providing the second internet document instead of the source internet document.

According to an embodiment of the invention, further includes instructions for storing, following the receiving of the granular element associated information, associated information metadata that includes metadata pertaining to the web user, wherein the second internet document includes at least part of the associated information metadata.

According to an embodiment of the invention, the computer readable code further includes instructions for receiving from another web user additional granular element associated information that is associated with a referenced granular element that is selected in response to a selection of the other web user; wherein the generating of the second internet document includes generating the second internet document that includes the at least one referenced granular element, other granular elements, the granular element associated information and the additional granular element information.

According to an embodiment of the invention, the instructions for the generating of the second internet document includes instructions for modifying a spatial relationship between two granular elements in order to insert the granular element associated information.

According to an embodiment of the invention, further comprising instructions for comparing, following the acquiring of die source internet document, at least one granular element of the source internet document to at least one granular element of a stored version of the source internet document which was acquired in a previous time, wherein the generating of die second internet document includes updating a stored version of the second internet document by inserting at least one granular element of the source internet document that is not included in the stored version of the second internet document.

According to an embodiment of the invention, the instructions for the acquiring of the source internet are carried out regardless of any user request, wherein the updating is followed by selectively notifying a web user of the updating, in response to at least one notification rule.

According to an embodiment of the invention, further including instructions for notifying another user, following the generating of the second Internet document, that granular element associated information was provided.

According to an embodiment of the invention, the instructions for the providing of the second internet document are responsive to a received query for the source internet document which is received via a browser-within-browser module, wherein the providing of the second internet document includes providing the second internet connection to the browser-within-browser module.

According to an embodiment of the invention, the acquiring of the source internet document is preceded by recording a series of user inputs used by the user for reaching an internet document, wherein the acquiring of the source internet document further includes repeating the series of user inputs for acquiring the source documents.

According to an embodiment of the invention, the instructions for the generating of the second internet document includes instructions for including in the second internet document at least one granular elements retrieved from an internet document other than the source internet document, which is accessible via a frame of the source internet document.

According to an embodiment of the invention, the instructions for the receiving of the granular element associated information includes instructions for receiving granular element associated information that is associated with a referenced Flash-based granular element.

According to an embodiment of the invention, the instructions for the receiving of the granular element associated information includes instructions for receiving granular element associated information that is associated with the referenced Flash-based granular element that is accessible only after a series of user inputs.

According to an embodiment of the invention, the instructions for the receiving of the granular element associated information includes instructions for receiving the granular element associated information that is associated with empty space granular element, that defines space between other granular elements.

According to an embodiment of the invention, the computer readable code further includes instructions for printing the second internet document.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method for managing content, the method comprising:
acquiring a source internet document over an internet connection;
dividing the source internet document into multiple granular elements, to provide a group of interrelated granular elements;
adding metadata fields to the granular elements;
receiving granular element associated information from a web user, wherein the granular element associated information is associated with a referenced granular element that is selected in response to user selection;
generating a second internet document that comprises the referenced granular element, other granular elements, and the granular element associated information, wherein the generating is responsive to metadata of at least one granular element; and
providing the second internet document over an internet connection.

2. The method according to claim 1, wherein a spatial relationship is defined for each of a group of granular elements in respect to at least one other granular element.

3. The method according to claim 1, wherein the providing of the second internet document comprises providing the second internet document to another web user.

4. The method according to claim 1, further comprising providing a user interface for marking a portion of the source internet document, wherein the referenced granular element is at least partly referenced by a marking of tile user.

5. The method according to claim 4, wherein the dividing is followed by generating at least one granular element in response to the marking of the user.

6. The method according to claim 4, further comprising recording a marking of the user using spatial parameter responsive to a graphic display of a browser-within-browser module.

7. The method according to claim 1, wherein the providing of the second internet document is responsive to a received query for the source internet document, and comprises providing the second internet document instead of the source internet document.

8. The method according to claim 1, wherein the receiving of the granular element associated information is followed by storing associated information metadata that comprises metadata pertaining to the web user, wherein the second internet document comprises at least part of the associated information metadata.

9. The method according to claim 1, further comprising:
receiving additional granular element associated information from another web user, wherein the additional granular element associated information is associated with a referenced granular element which is selected in response to a selection of the other web user;
wherein the generating of the second internet document comprises generating the second internet document that further comprises the additional granular element information.

10. The method according to claim 1, wherein the generating of the second internet document comprises modifying a spatial relationship between two granular elements in order to insert the granular element associated information.

11. The method according to claim 1, wherein the acquiring of the source internet is carried out regardless of any user request; wherein the acquiring of the source internet document is followed by comparing at least one granular element of the source internet document to at least one granular element of a stored version of the source internet document which was acquired in a previous time, wherein the generating of the second internet document comprises updating a stored version of the second internet document by inserting at least one granular element of the source internet document that is not comprised in the stored version of the second internet document, wherein the updating is followed by selectively notifying a web user of the updating, in response to at least one notification rule.

12. The method according to claim 1, wherein the generating of the second internet document is followed by notifying another user that granular element associated information was provided.

13. The method according to claim 1, wherein the acquiring of the source internet document is preceded by recording a series of user inputs used by the user for reaching an internet document, wherein the acquiring of the source internet document further comprises repeating the series of user inputs for acquiring the source documents; wherein the providing of the second internet document is responsive to a received query for the source internet document which is received via a browser-within-browser module, wherein the providing of the second internet document comprises providing the second internet connection to the browser-within-browser module.

14. The method according to claim 1, wherein the generating of the second internet document comprises including in the second internet document at least one granular elements retrieved from an internet document other than the source internet document, which is accessible via a frame of the source internet document.

15. The method according to claim 1, wherein the receiving of the granular element associated information comprises receiving granular element associated information that is associated with a referenced Flash-based granular element.

16. The method according to claim 1, wherein the receiving of the granular element associated information comprises receiving the granular element associated information that is associated with empty space granular element, that defines space between other granular elements.

17. The method according to claim 1, further comprising printing the second internet document.

18. The method according to claim 1, wherein metadata of at least one granular element pertains to relevancy of search queries to the granular element.

19. The method according to claim 1, wherein metadata of at least one granular element pertains to a ranking of the granular element that is responsive to viewing of the granular element by users.

20. The method according to claim 1, wherein metadata of at least one granular element pertains to temporal parameters of the granular element.

21. The method according to claim 1, wherein the generating comprises generating the second internet document in response to properties of a target recipient.

22. The method according to claim 1, comprising generating multiple second internet documents that pertains to the source internet document, wherein different second internet document use at least one shared granular element, for reducing data duplication.

23. The method according to claim 1, wherein the dividing comprises dividing content of the source internet document in response to metadata associated with portions of the source internet document.

24. The method according to claim 1, wherein the dividing comprises subdividing a portion of the source internet document in response to content of the portion.

25. The method according to claim 1, wherein the dividing comprises dividing a portion of the source internet document in response to type of the content of the portion.

26. The method according to claim 1, further comprising transmitting the second internet document to a cellular device over a cellular telephony network, for displaying by the cellular device.

27. A system for managing content, the system comprising:
a memory for storing a source internet document that has been acquired over an internet connection;
a processor, configured to divide the source internet document into multiple granular elements, and to provide a group of interrelated granular elements;
and to add metadata fields to the granular elements;
wherein the processor is further configured to process granular element associated information that has been received from a web user, wherein the granular element associated information is associated with a referenced granular element that is selected in response to user selection, for generating, in response to metadata of at least one granular element, a second internet document that comprises the referenced granular element, other granular elements, and the granular element associated information; and
an interface for providing the second internet document over an internet connection.

28. A computer readable medium having a computer readable code embodied therein for managing content, the computer readable code comprising instructions for:
acquiring a source internet document over an internet connection;
dividing the source internet document into multiple granular elements, to provide a group of interrelated granular elements;
adding metadata fields to the granular elements;
receiving granular element associated information from a web user, wherein the granular element associated information is associated with a referenced granular element that is selected in response to user selection;
generating a second internet document that comprises the referenced granular element, other granular elements, and the granular element associated information, wherein the generating is responsive to metadata of at least one granular element; and
providing the second internet document over an internet connection.
